(19) United States
(12) Patent Application Publication
(10) Pub. No.: US 2013/0282370 A1
(43) Pub. Date: Oct. 24, 2013

(54) SPEECH PROCESSING APPARATUS, CONTROL METHOD THEREOF, STORAGE MEDIUM STORING CONTROL PROGRAM THEREOF, AND VEHICLE, INFORMATION PROCESSING APPARATUS, AND INFORMATION PROCESSING SYSTEM INCLUDING THE SPEECH PROCESSING APPARATUS

(71) Applicants: Takayuki Arakawa, Tokyo (JP); Akihiko Sugiyama, Tokyo (JP)

(72) Inventors: Takayuki Arakawa, Tokyo (JP); Akihiko Sugiyama, Tokyo (JP)

(73) Assignee: NEC CORPORATION, Tokyo (JP)

(21) Appl. No.: 13/978,446

(22) PCT Filed: Dec. 3, 2011
(86) PCT No.: PCT/JP2011/077996

§ 371 Date: Jul. 5, 2013

(30) Foreign Application Priority Data
Jan. 13, 2011 (JP) 2011-005316

(51) Int. Cl. G10L 21/0208

(52) U.S. Cl. CPC G10L 21/0208
USPC 704/226

(57) ABSTRACT

An apparatus of this invention is a speech processing apparatus that acquires pseudo speech from a mixture sound including desired speech and noise. The speech processing apparatus includes a first microphone that inputs a first mixture sound including desired speech and noise and outputs a first mixture signal, a second microphone that is opened to the same sound space as that of the first microphone, inputs a second mixture sound including the desired speech and the noise at a ratio different from the first mixture sound, and outputs a second mixture signal, a first sound collector including a concave surface that collects the first mixture sound to the first microphone, a second sound collector including a concave surface that collects the second mixture sound to the second microphone and disposed in a direction different from the first sound collector, and a noise suppression circuit that suppresses an estimated noise signal based on the first mixture signal and the second mixture signal and outputs a pseudo speech signal. With this arrangement, it is possible to, in a single sound space where desired speech and noise mix, collect the desired speech and the noise, correctly estimate the noise, and reconstruct pseudo speech close to the desired speech.

### TECHNICAL FIELD

The present invention relates to a technique of acquiring pseudo speech from a mixture sound including desired speech and noise.

### BACKGROUND ART

In the above-described technical field, patent literature 1 discloses a technique of suppressing, in a vehicle, noise that has come from outside the car and mixed with speech in the car. In patent literature 1, the outside-car noise is suppressed using an adaptive filter based on the output signal of a microphone that picks up the in-car speech and the output signal of a microphone that picks up the outside-car noise.

### CITATION LIST

### Patent Literature

Patent literature 1: Japanese Patent Laid-Open No. 2-246599

### SUMMARY OF THE INVENTION

### Technical Problem

However, the technique of patent literature 1 is configured to shield a minor one of desired speech and noise input to the microphones. For this reason, if the desired speech input to the microphone that picks up speech is weak, the reconstructed pseudo speech is weak, too. On the other hand, if the noise picked up by the microphone that picks up noise is weak, the accuracy of estimating the noise to be suppressed lowers, and the reconstructed pseudo speech is unstable.

The present invention enables to provide a technique of solving the above-described problem.

### Solution to Problem

One aspect of the present invention provides a speech processing apparatus comprising:

a first microphone that inputs a first mixture sound including desired speech and noise and outputs a first mixture signal;

a second microphone that is opened to the same sound space as that of the first microphone, inputs a second mixture sound including the desired speech and the noise at a ratio different from the first mixture sound, and outputs a second mixture signal;

a first sound collector including a concave surface that collects the first mixture sound to the first microphone;

a second sound collector including a concave surface that collects the second mixture sound to the second microphone and disposed in a direction different from the first sound collector; and

a noise suppression circuit that suppresses an estimated noise signal based on the first mixture signal and the second mixture signal and outputs a pseudo speech signal.

Another aspect of the present invention provides a vehicle including the speech processing apparatus,

wherein the first microphone and the first sound collector are disposed at a position where the first sound collector collects desired speech uttered by an occupant in a car to the first microphone, and

the second microphone and the second sound collector are disposed at a position where the second sound collector collects noise generated from a noise source in the car to the second microphone.

Still other aspect of the present invention provides an information processing apparatus including the speech processing apparatus,

wherein the first microphone and the first sound collector are disposed at a position where the first sound collector collects desired speech uttered by an operator of the information processing apparatus to the first microphone, and

the second microphone and the second sound collector are disposed at a position where the first sound collector collects noise generated from a noise source in the same sound space as the operator to the second microphone.

Still other aspect of the present invention provides an information processing system including the speech processing apparatus, comprising:

a speech recognition apparatus that recognizes desired speech from the pseudo speech signal output from the speech processing apparatus; and

an information processing apparatus that processes information in accordance with the desired speech recognized by the speech recognition apparatus.

Still other aspect of the present invention provides a control method of a speech processing apparatus including:

a first microphone that inputs a first mixture sound including desired speech and noise and outputs a first mixture signal;

a second microphone that is opened to the same sound space as that of the first microphone, inputs a second mixture sound including the desired speech and the noise at a ratio different from the first mixture sound, and outputs a second mixture signal;

a first sound collector including a concave surface that collects the first mixture sound to the first microphone;

a second sound collector including a concave surface that collects the second mixture sound to the second microphone and disposed in a direction different from the first sound collector; and

a noise suppression circuit that suppresses an estimated noise signal based on the first mixture signal and the second mixture signal and outputs a pseudo speech signal, the method comprising:

acquiring a parameter of the noise suppression circuit;

determining, in accordance with the parameter of the noise suppression circuit, a direction of the second sound collector to increase the ratio of the noise in the second mixture sound input to the second microphone; and

controlling the direction of the second sound collector.

Still other aspect of the present invention provides a non-transitory computer-readable storage medium storing a control program of a speech processing apparatus including:

a first microphone that inputs a first mixture sound including desired speech and noise and outputs a first mixture signal;

a second microphone that is opened to the same sound space as that of the first microphone, inputs a second mixture sound including the desired speech and the noise at a ratio different from the first mixture sound, and outputs a second mixture signal;

a first sound collector including a concave surface that collects the first mixture sound to the first microphone;

a second sound collector including a concave surface that collects the second mixture sound to the second microphone and disposed in a direction different from the first sound collector; and

a noise suppression circuit that suppresses an estimated noise signal based on the first mixture signal and the second mixture signal and outputs a pseudo speech signal, the control program causing a computer to execute:

acquiring a parameter of the noise suppression circuit;

determining, in accordance with the parameter of the noise suppression circuit, a direction of the second sound collector to increase the ratio of the noise in the second mixture sound input to the second microphone; and

controlling the direction of the second sound collector.

### Advantageous Effects of Invention

According to the present invention, it is possible to, in a single sound space where desired speech and noise mix, collect the desired speech and the noise, correctly estimate the noise, and reconstruct pseudo speech close to the desired speech.

### BRIEF DESCRIPTION OF THE DRAWINGS

FIG. 1 is a block diagram showing the arrangement of a speech processing apparatus according to the first embodiment of the present invention;

FIG. 2 is a block diagram showing the arrangement of an information processing system including a speech processing apparatus according to the second embodiment of the present invention;

FIG. 3A is a view showing an example of a microphone set including fixed sound collectors according to the second embodiment of the present invention;

FIG. 3B is a view showing another example of the microphone set including the fixed sound collectors according to the second embodiment of the present invention;

FIG. 4A is a view for explaining sound collection by a sound collector of a quadratic surface according to the second embodiment of the present invention;

FIG. 4B is a view for explaining sound collection by a sound collector of a pseudo surface according to the second embodiment of the present invention;

FIG. 5 is a view showing the arrangement of a noise suppression circuit according to the second embodiment of the present invention;

FIG. 6 is a block diagram showing the arrangement of an information processing system including a speech processing apparatus according to the third embodiment of the present invention;

FIG. 7 is a view showing an example of a microphone set including a moving second sound collector according to the third embodiment of the present invention;

FIG. 8 is a view showing another example of the microphone set including the moving second sound collector according to the third embodiment of the present invention;

FIG. 9 is a block diagram showing the hardware arrangement of the speech processing apparatus according to the third embodiment of the present invention;

FIG. 10 is a view showing the arrangement of a sound collector position control parameter DB according to the third embodiment of the present invention;

FIG. 11 is a flowchart showing a speech processing procedure according to the third embodiment of the present invention;

FIG. 12A is a flowchart showing the first example of the second sound collector adjustment procedure according to the third embodiment of the present invention;

FIG. 12B is a flowchart showing the second example of the second sound collector adjustment procedure according to the third embodiment of the present invention;

FIG. 12C is a flowchart showing the third example of the second sound collector adjustment procedure according to the third embodiment of the present invention;

FIG. 13 is a block diagram showing the arrangement of an information processing system including a speech processing apparatus according to the fourth embodiment of the present invention;

FIG. 14 is a flowchart showing a speech processing procedure according to the fourth embodiment of the present invention;

FIG. 15 is a block diagram showing the arrangement of a vehicle system that is an information processing system including a speech processing apparatus according to the fifth embodiment of the present invention;

FIG. 16 is a block diagram showing the arrangement of a vehicle system that is an information processing system including a speech processing apparatus according to the sixth embodiment of the present invention;

FIG. 17 is a block diagram showing the arrangement of a personal computer that is an information processing system including a speech processing apparatus according to the seventh embodiment of the present invention; and

FIG. 18 is a block diagram showing the arrangement of a personal computer that is an information processing system including a speech processing apparatus according to the eighth embodiment of the present invention.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

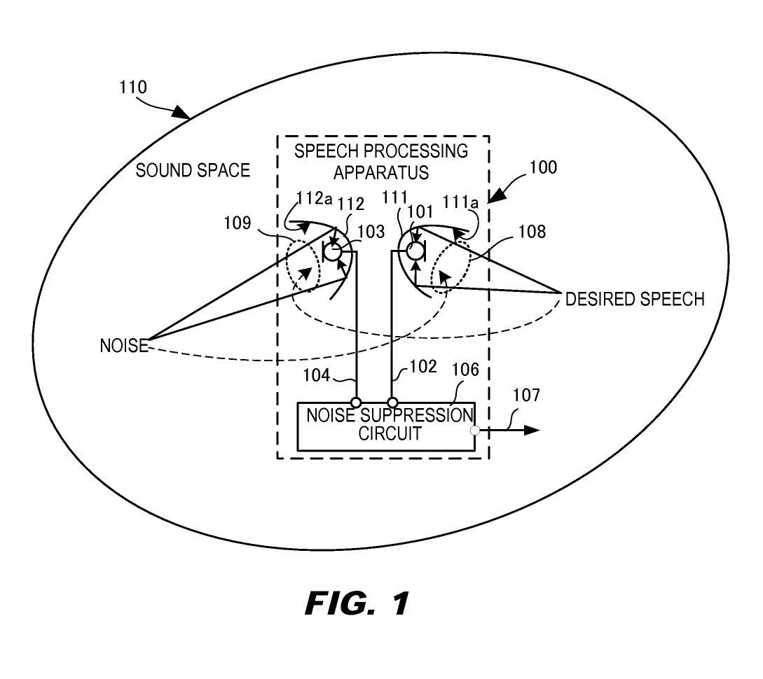

A speech processing apparatus 100 according to the first embodiment of the present invention will be described with reference to FIG. 1. As shown in FIG. 1, the speech processing apparatus 100 includes a first microphone 101, a second microphone 103, a first sound collector 111, a second sound collector 112, and a noise suppression circuit 106. The first microphone 101 inputs a first mixture sound 108 including desired speech and noise, and outputs a first mixture signal 102. The second microphone 103 is opened to a sound space 110 that is the same as the sound space of the first microphone 101. The second microphone 103 inputs a second mixture sound 109 including the desired speech and the noise at a ratio different from the first mixture sound 108, and outputs a second mixture signal 104. The first sound collector 111 includes a concave surface 111a that collects the first mixture sound 108 to the first microphone 101. The second sound collector 112 includes a concave surface 112a that collects the second mixture sound 109 to the second microphone 103 and is disposed in a direction different from the first sound collector 111. The noise suppression circuit 106 suppresses an estimated noise signal based on the first mixture signal 102 and the second mixture signal 104, and outputs a pseudo speech signal 107.

According to this embodiment, it is possible to, in a single sound space where desired speech and noise mix, collect the desired speech and the noise by the sound collectors, respectively, correctly estimate the noise, and reconstruct pseudo speech close to the desired speech.

### Second Embodiment

In the second embodiment, a microphone set is provided in which a first microphone, a second microphone, a first sound collector, and a second sound collector are integrally fixed. Disposing the microphone set at a desired position in consideration of the positions of the speech source and the noise source makes it possible to, in a single sound space where desired speech and noise mix, collect the desired speech and the noise, correctly estimate the noise, and reconstruct pseudo speech close to the desired speech.

<Arrangement of Information Processing System Including Speech Processing Apparatus According to this Embodiment>

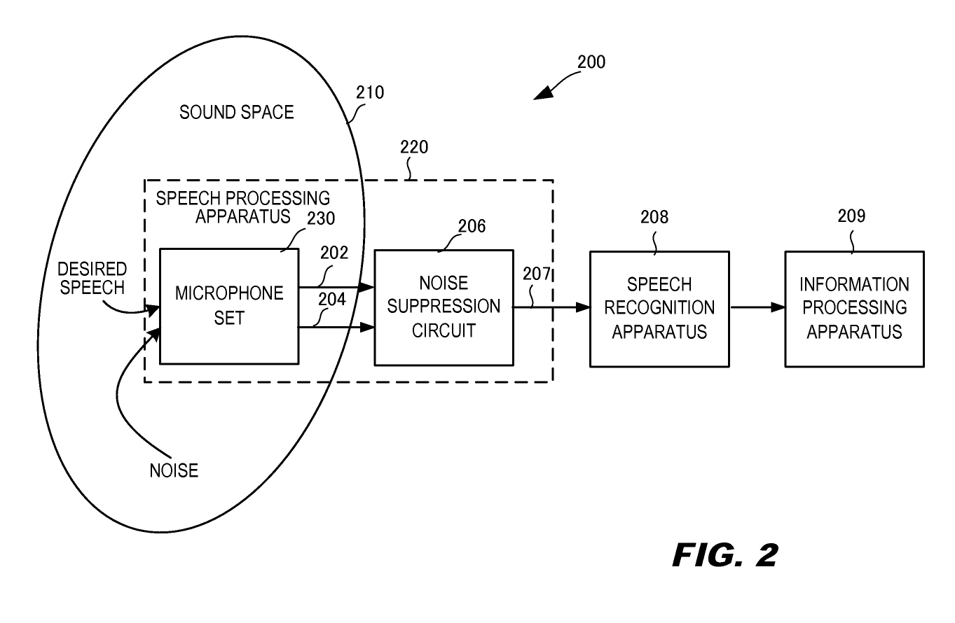

FIG. 2 is a block diagram showing the arrangement of an information processing system 200 including a speech processing apparatus 220 according to this embodiment. Note that referring to FIG. 2, the speech processing apparatus 220 includes a microphone set 230 in which a first microphone, a second microphone, a first sound collector, and a second sound collector are integrally fixed, and a noise suppression circuit 206. The information processing system 200 includes the speech processing apparatus 220, and additionally, a speech recognition apparatus 208 and an information processing apparatus 209.

The first microphone in the microphone set 230 converts a first mixture sound including the desired speech collected by the first sound collector and noise that has got around into a first mixture signal 202 including a speech signal and a noise signal and transmits it to the noise suppression circuit 206. On the other hand, the second microphone in the microphone set 230 receives a second mixture sound including noise collected by the second sound collector and speech that has got around at a ratio different from the first mixture sound. The second microphone converts the second mixture sound into a second mixture signal 204 including a speech signal and a noise signal at a ratio different from the first mixture signal and transmits it to the noise suppression circuit 206.

The noise suppression circuit 206 outputs a pseudo speech signal 207 based on the transmitted first mixture signal 202 and second mixture signal 204. The pseudo speech signal 207 is recognized by the speech recognition apparatus 208, and the information processing apparatus 209 processes information based on the recognized speech. The information processing apparatus 209 can, for example, either perform processing according to a message by speech or process the speech input itself as information.

In the above-described way, the mixture sound including the desired speech and noise generated in the same sound space is input, at different mixture ratios, to the first microphone to which the desired speech is collected by the concave portion of the first sound collector and the second microphone to which the noise is collected by the concave portion of the second sound collector. The noise suppression circuit 206 reconstructs the pseudo speech signal based on the first mixture signal from the first microphone and the second mixture signal from the second microphone. The speech recognition apparatus 208 recognizes the reconstructed pseudo speech signal. The information processing apparatus 209 processes information based on the recognized speech.

Note that the signal lines that transmit the first mixture signal 202 and the second mixture signal 204 may transmit the return signal of a ground power supply or the like or a power supply for operating the microphone. The noise suppression circuit 206 may be attached to the microphone set 230. In this case, the pseudo speech signal is output from the microphone set. In this embodiment, speech recognition will be explained. However, the present invention is not limited to this, and correct reconstruction of the uttered speech is useful in another processing as well. For example, application to a telephone or application to a manipulation of a vehicle or a device is also possible.

<Arrangement of Microphone Set Including Fixed Sound Collectors According to this Embodiment>

In this embodiment, the first and second sound collectors are stationarily disposed at predetermined positions in advance. Two examples of the arrangement of the microphone set will be explained below. However, the present invention is not limited to those.

(Example of Microphone Set Including Fixed Sound Collectors)

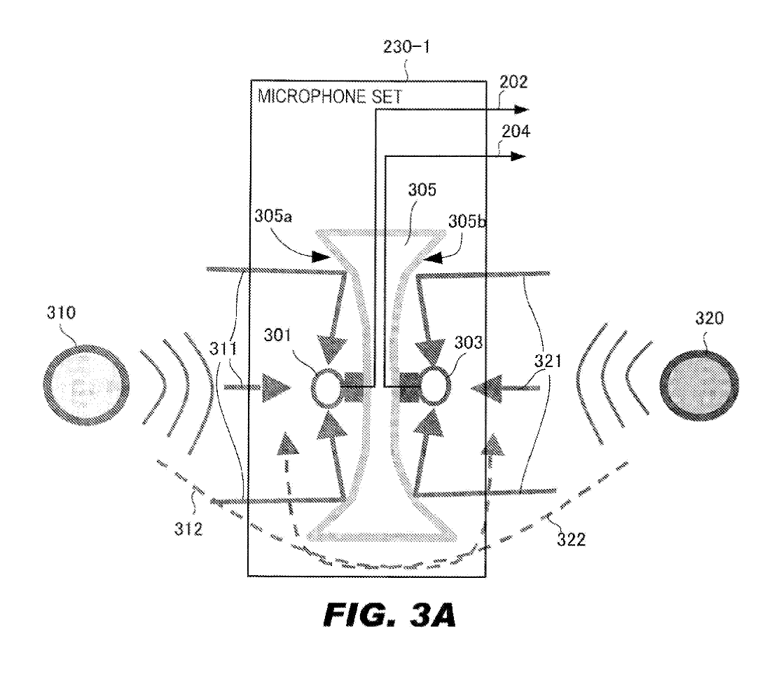

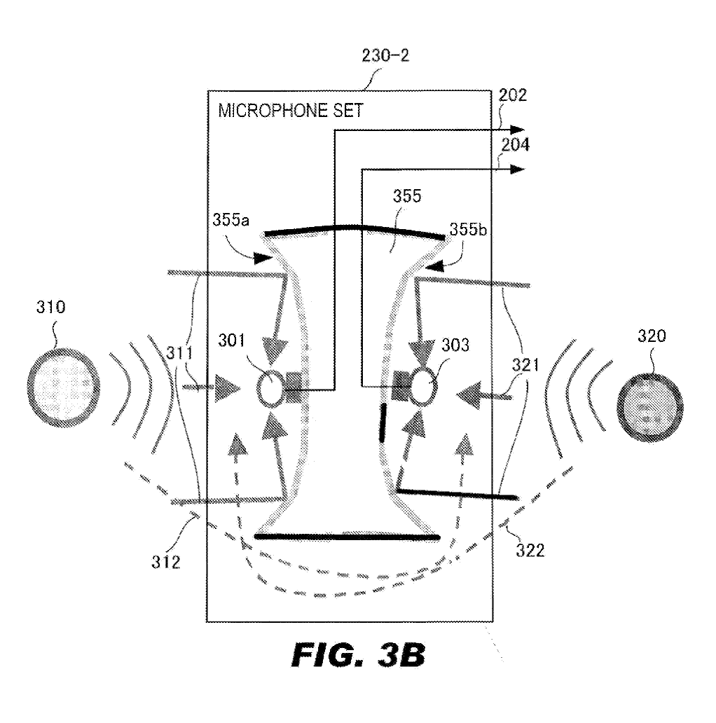

FIG. 3A is a view showing an example 230-1 of the microphone set 230 including the fixed sound collectors according to this embodiment.

The microphone set 230-1 includes a first microphone 301, a second microphone 303, a microphone support member 305 having the first microphone 301 and the second microphone 303 disposed on both sides. In the microphone support member 305, each of sound reflecting surfaces 305a and 305b on which the first microphone 301 and the second microphone 303 are disposed is a concave surface formed from a quadratic surface or a pseudo surface approximating a quadratic surface. The first microphone 301 and the second microphone 303 are disposed at the focus positions of the quadratic surfaces or the pseudo surfaces approximating quadratic surfaces. As shown in FIG. 3A, the sound reflecting surfaces 305a and 305b of the microphone support member 305 are formed symmetrically. The first microphone 301 and the second microphone 303 are disposed symmetrically on both sides of the microphone support member 305. That is, the first microphone 301 is attached to one surface of the microphone support member 305, and the second microphone is attached to the other surface of the microphone support member 305. The first microphone 301 and the second microphone 303 output the first mixture signal 202 and the second mixture signal 204 to the noise suppression circuit 206, respectively.

Referring to FIG. 3A, out of the speech from a speech source 310 that utters the desired speech, speech 311 toward the sound reflecting surface 305a that is a quadratic surface or a pseudo surface approximating a quadratic surface is reflected by the sound reflecting surface 305a and collected to the first microphone 301. Hence, the sound reflecting surface 305a functions as the first sound collector. Noise 322 from a noise source 320 that generates noise also gets around, and a first mixture sound including the noise 322 and the collected speech 311 is input to the first microphone 301. On the other hand, out of the noise from the noise source 320, noise 321 toward the sound reflecting surface 305b that is a quadratic surface or a pseudo surface approximating a quadratic surface is reflected by the sound reflecting surface 305b and collected to the second microphone 303. Hence, the sound reflecting surface 305b functions as the second sound collector. Speech 312 from the speech source 310 also gets around, and a second mixture sound including the speech 312 and the collected noise 321 is input to the second microphone 303.

Note that the microphone support member 305 is preferably a sound insulator that shields sound transmission.

(Another Example of Microphone Set Including Fixed Sound Collectors)

FIG. 3B is a view showing another example 230-2 of the microphone set 230 including the fixed sound collectors according to this embodiment.

The microphone set 230-2 includes the first microphone 301, the second microphone 303, a microphone support member 355 having the first microphone 301 and the second microphone 303 disposed on both sides. In the microphone support member 355, each of sound reflecting surfaces 355a and 355b on which the first microphone 301 and the second microphone 303 are disposed is a concave surface formed from a quadratic surface or a pseudo surface approximating a quadratic surface. The first microphone 301 and the second microphone 303 are disposed at the focus positions of the quadratic surfaces or the pseudo surfaces approximating quadratic surfaces. As shown in FIG. 3B, the sound reflecting surfaces 355a and 355b of the microphone support member 355 are formed at angles so that the axes of the curved surfaces are directed to the sound source and the noise source, respectively. The first microphone 301 and the second microphone 303 output the first mixture signal 202 and the second mixture signal 204 to the noise suppression circuit 206, respectively.

Referring to FIG. 3B, out of the speech from the speech source 310 that utters the desired speech, the speech 311 toward the sound reflecting surface 355a that is a quadratic surface or a pseudo surface approximating a quadratic surface is reflected by the sound reflecting surface 355a and collected to the first microphone 301. Hence, the sound reflecting surface 355a functions as the first sound collector. The noise 322 from the noise source 320 that generates noise also gets around, and a first mixture sound including the noise 322 and the collected speech 311 is input to the first microphone 301. On the other hand, out of the noise from the noise source 320, the noise 321 toward the sound reflecting surface 355b that is a quadratic surface or a pseudo surface approximating a quadratic surface is reflected by the sound reflecting surface 355b and collected to the second microphone 303. Hence, the sound reflecting surface 355b functions as the second sound collector. The speech 312 from the speech source 310 also gets around, and a second mixture sound including the speech 312 and the collected noise 321 is input to the second microphone 303.

Note that the microphone support member 355 is preferably a sound insulator that shields sound transmission. The sound insulator preferably uses a substance having a large mass and a high density. Such a substance needs a larger energy to oscillate and can therefore prevent a sound from passing through. The sound insulator preferably uses a hard material for the surface and a soft material for the interior. A hard material easily reflects a sound. For this reason, when a hard material is used for the surface of the sound insulator, a sound reflected by the sound insulator can also be collected in addition to a sound directly input to the microphone. A soft material easily absorbs a sound. For this reason, when a soft material is used for the interior of the sound insulator, unnecessary sound penetration can be prevented. The surface part on the first microphone side and the surface part on the second microphone side are preferably not continuous but separated. In a continuous structure, a sound propagates through the surface part and passes through the sound insulator. To prevent this, the sound insulator preferably has a three-layer structure in which a part made of a soft material is sandwiched between two surface parts made of a hard material.

<Explanation of Sound Collection by Sound Collector According to this Embodiment>

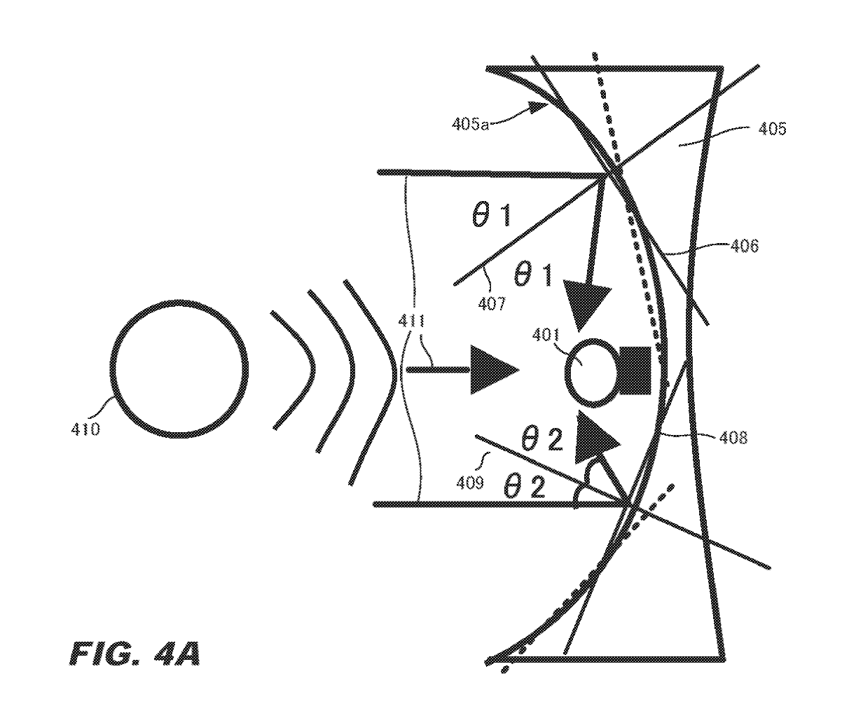

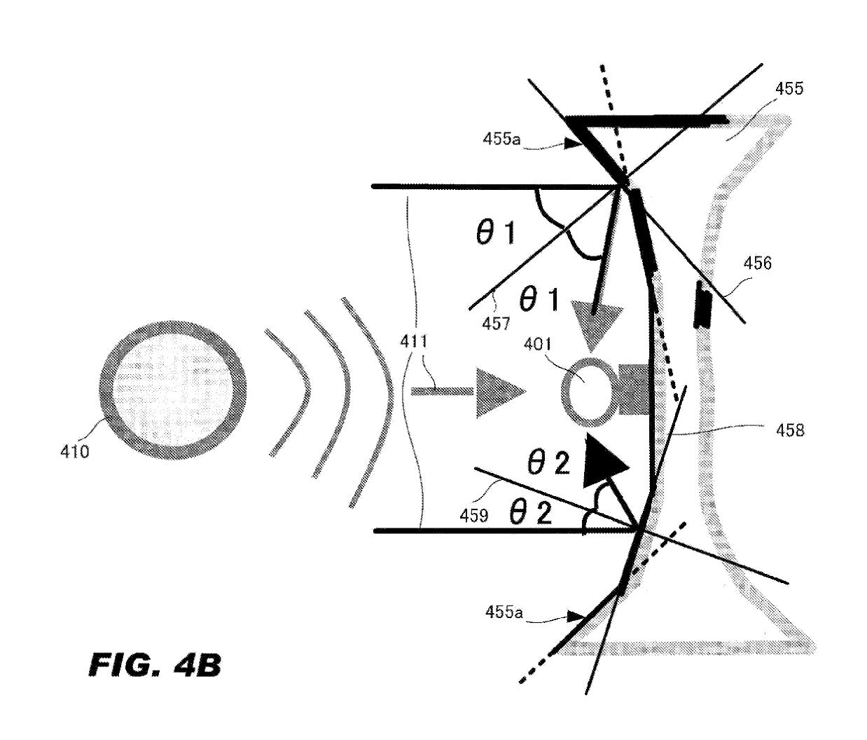

Sound collection, to the focus positions, by the sound reflecting surfaces 305a, 305b, 355a, and 355b that are quadratic surfaces or pseudo surfaces approximating quadratic surfaces shown in FIGS. 3A and 3B will be described below with reference to FIG. 4A concerning the quadratic surface and FIG. 4B concerning the pseudo surface approximating a quadratic surface.

(Sound Collection by Sound Collector of Quadratic Surface)

FIG. 4A is a view for explaining sound collection by a microphone support member 405 including a quadratic surface 405a serving as the sound collector according to this embodiment.

Referring to FIG. 4A, line segments 406 and 408 are the tangential lines of the quadratic surface 405a. A sound 411 from a sound source 410 is reflected at equal angles θ1 and θ2 with respect to normals 407 and 409 that perpendicularly cross the line segments 406 and 408 at the contacts to the quadratic surface 405a, respectively. The sound 411 is collected to a microphone 401 located at the focal point of the quadratic surface 405a.

(Sound Collection by Sound Collector of Pseudo Surface)

FIG. 4B is a view for explaining sound collection by a microphone support member 455 including a pseudo surface 455a serving as the sound collector according to this embodiment. The pseudo surface 455a is an aggregate of planes extending in the tangential directions of a quadratic surface.

Referring to FIG. 4B, line segments 456 and 458 are surfaces of the pseudo surface 455a. The sound 411 from the sound source 410 is reflected at the equal angles θ1 and θ2 with respect to normals 457 and 459 that perpendicularly cross the line segments 456 and 458, respectively. The sound 411 is collected to the microphone 401 located at the focal point of the pseudo surface 455a.

<Arrangement of Noise Suppression Circuit>

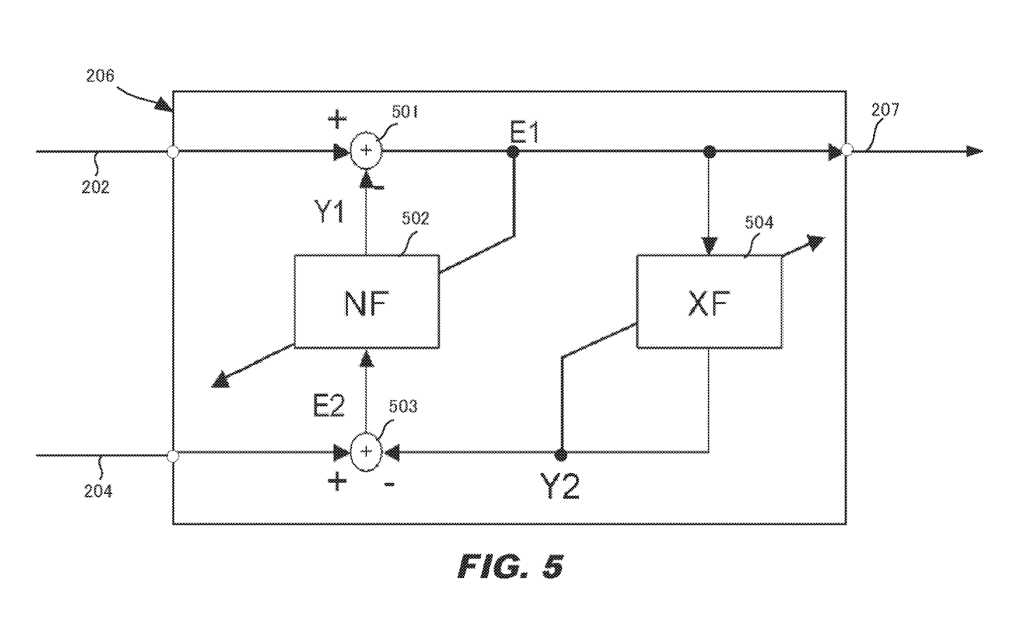

FIG. 5 is a view showing the arrangement of the noise suppression circuit 206 according to this embodiment.

The noise suppression circuit 206 includes a subtracter 501 that subtracts, from the first mixture signal 202, an estimated noise signal Y1 estimated to be included in the first mixture signal 202. The noise suppression circuit 206 also includes a subtracter 503 that subtracts, from the second mixture signal 204, an estimated speech signal Y2 estimated to be included in the second mixture signal 204. The noise suppression circuit 206 also includes an adaptive filter NF 502 serving as an estimated noise signal generator that generates the estimated noise signal Y1 from a pseudo noise signal E2 output from the subtracter 503. The noise suppression circuit 206 also includes an adaptive filter XF 504 serving as an estimated speech signal generator that generates the estimated speech signal Y2 from a pseudo speech signal E1 (207) output from the subtracter 503. A detailed example of the adaptive filter XF 504 is described in International Publication No. 2005/024787. Even when the target speech gets around and is input to the second microphone 303, and the second mixture signal 204 includes the speech signal, the adaptive filter XF 504 can prevent the subtracter 501 from erroneously removing the speech signal of the speech that has got around from the first mixture signal 202.

With this arrangement, the subtracter 501 subtracts the estimated noise signal Y1 from the first mixture signal 202 transmitted from the first microphone 301 and outputs the pseudo speech signal E1 (207).

The estimated noise signal Y1 is generated from the pseudo noise signal E2 by the adaptive filter NF 302 using a parameter that changes based on the pseudo speech signal E1 (207). The pseudo noise signal E2 is obtained by causing the subtracter 503 to subtract the estimated speech signal Y2 from the second mixture signal 204 transmitted from the second microphone 303 through a signal line.

The estimated speech signal Y2 is generated from the pseudo speech signal E1 (207) by the adaptive filter XF 504 using a parameter that changes based on the estimated speech signal Y2.

Note that the noise suppression circuit 206 can be an analog circuit, a digital circuit, or a circuit including both. When the noise suppression circuit 206 is an analog circuit, and the pseudo speech signal E1 (207) is used for digital control, an A/D converter converts the signal into a digital signal. On the other hand, when the noise suppression circuit 206 is a digital circuit, the signal from the microphone is converted into a digital signal by an A/D converter before input to the noise suppression circuit 206. If both an analog circuit and a digital circuit are included, for example, the subtracter 501 or 503 may be formed from an analog circuit, and the adaptive filter NF 502 or the adaptive filter XF 504 is formed from an analog circuit controlled by a digital circuit. The noise suppression circuit 206 shown in FIG. 5 is one of examples of the circuit suitable for this embodiment. An existing circuit that subtracts the estimated noise signal from the first mixture signal and outputs the pseudo speech signal is usable. The characteristic structure of this embodiment including the two microphones and the sound insulator enables to suppress noise. For example, the adaptive filter XF 504 shown in FIG. 5 may be replaced with a circuit that outputs a predetermined level to filter diffused speech. The subtracter 501 and/or the subtracter 503 may be replaced with an integrator by expressing a coefficient for integrating the estimated noise signal Y1 or the estimated speech signal Y2 with the first mixture signal 202 or the second mixture signal 204.

### Third Embodiment

In the second embodiment, an example has been described in which the first microphone and the second microphone of a microphone set are fixed in predetermined directions on the microphone support member. In the third embodiment, an example in which the microphone support member moves to allow the second sound collector to change its direction or an example, in which the second sound collector direction itself can move will be explained. The second sound collector moves to increase the noise input. According to this embodiment, the second microphone inputs larger noise, thereby increasing the correctness of noise to be suppressed by the noise suppression circuit and the correctness of pseudo speech to be output. Note that a description of an arrangement and processing common to the second embodiment will be omitted.

<Arrangement of Information Processing System Including Speech Processing Apparatus According to this Embodiment>

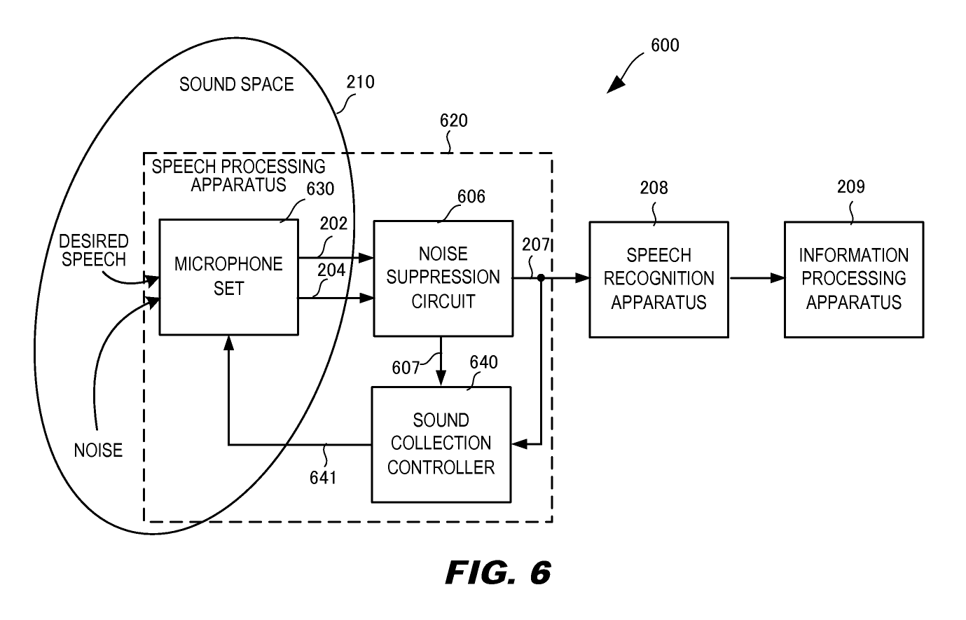

FIG. 6 is a block diagram showing the arrangement of an information processing system 600 including a speech processing apparatus 620 according to this embodiment. Note that referring to FIG. 6, the speech processing apparatus 620 includes a microphone set 630 in which a first microphone, a second microphone, a first sound collector, a second sound collector, and a moving unit that moves the second sound collector are integrally fixed, a noise suppression circuit 606, and a sound collection controller 640. The information processing system 600 includes the speech processing apparatus 620, and additionally, a speech recognition apparatus 208 and an information processing apparatus 209.

The first microphone in the microphone set 630 converts a first mixture sound including desired speech collected by the first sound collector and noise that has got around into a first mixture signal 202 including a speech signal and a noise signal and transmits it to the noise suppression circuit 606. On the other hand, the second microphone in the microphone set 630 receives a second mixture sound including noise collected by the second sound collector and speech that has got around at a ratio different from the first mixture sound. The second microphone converts the second mixture sound into a second mixture signal 204 including a speech signal and a noise signal at a ratio different from the first mixture signal and transmits it to the noise suppression circuit 606. In this embodiment, the second sound collector in the microphone set 630 moves based on a control signal 641 from the sound collection controller 640 so as to obtain larger noise input.

The noise suppression circuit 606 outputs a pseudo speech signal 207 based on the transmitted first mixture signal 202 and second mixture signal 204. The pseudo speech signal 207 is recognized by the speech recognition apparatus 208, and the information processing apparatus 209 processes information based on the recognized speech. The information processing apparatus 209 can, for example, either perform processing according to a message by speech or process the speech input itself as information.

The sound collection controller 640 outputs the control signal 641 that changes the sound collection direction of the second sound collector in the microphone set 630 based on the pseudo speech signal 207 or the parameter 607 of the noise suppression circuit 606.

In the above-described way, the mixture sound including the desired speech and noise generated in the same sound space is input, at different mixture ratios, to the first microphone to which the desired speech is collected by the first sound collector and the second microphone to which the noise is collected by the second sound collector. The noise suppression circuit 606 reconstructs the pseudo speech signal based on the first mixture signal from the first microphone and the second mixture signal from the second microphone. The speech recognition apparatus 208 recognizes the reconstructed pseudo speech signal. The information processing apparatus 209 processes information based on the recognized speech.

Note that the signal lines that transmit the first mixture signal 202 and the second mixture signal 204 may transmit the return signal of a ground power supply or the like or a power supply for operating the microphone. The noise suppression circuit 606 or the sound collection controller 640 may be attached to the microphone set 630. In this case, the pseudo speech signal is output from the microphone set. In this embodiment, speech recognition will be explained. However, the present invention is not limited to this, and correct reconstruction of the uttered speech is useful in another processing as well. For example, application to a telephone or application to a manipulation of a vehicle or a device is also possible.

<Arrangement of Microphone Set Including Moving Sound Collector According to this Embodiment>

In this embodiment, the second sound collector moves to collect noise. Two examples of the arrangement of the microphone set will be explained below. However, the present invention is not limited to those.

(Example of Microphone Set Including Moving Sound Collector)

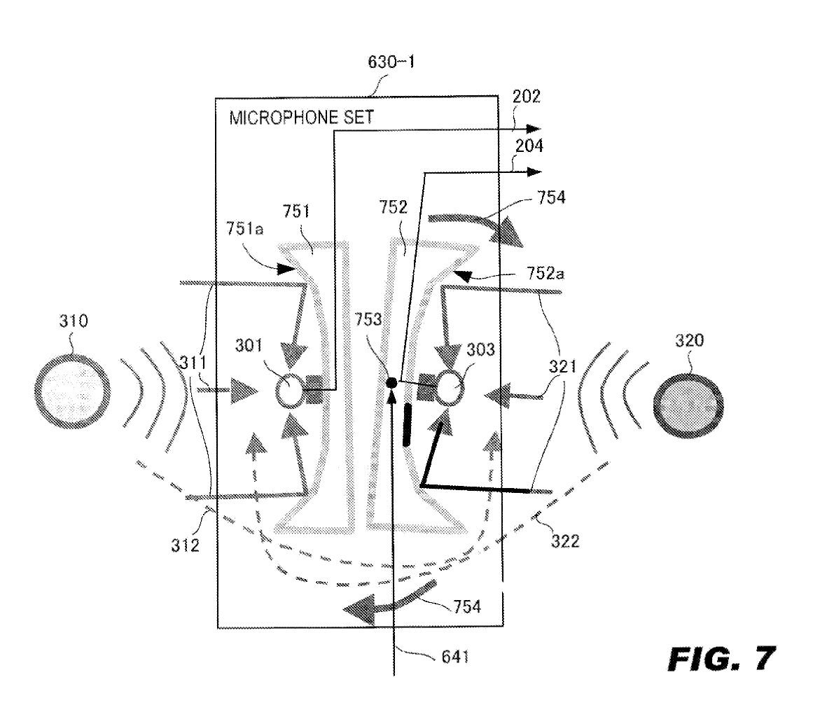

FIG. 7 is a view showing an example 630-1 of the microphone set 630 including a sound reflecting surface 752a serving as the moving second sound collector according to this embodiment. Note that the moving unit that moves the second sound collector is not illustrated. For example, a stepping motor or the like is disposed to automatically adjust the direction of the second sound collector.

The microphone set 630-1 includes a first microphone 301, a second microphone 303, a first microphone support member 751 on which the first microphone 301 is disposed, and a second microphone support member 752 on which the second microphone 303 is disposed. In the first microphone support member 751 and the first microphone support member 752, each of sound reflecting surfaces 751a and 752a on which the first microphone 301 and the second microphone 303 are disposed is a concave surface formed from a quadratic surface or a pseudo surface approximating a quadratic surface. The first microphone 301 and the second microphone 303 are disposed at the focus positions of the quadratic surfaces or the pseudo surfaces approximating quadratic surfaces. As shown in FIG. 7, the first microphone support member 751 is disposed in a predetermined direction to collect desired speech. However, the second microphone support member 752 is installed in a direction to collect noise so as to be rotatable about an axis 753 in the directions of arrows 754. The first microphone 301 and the second microphone 303 output the first mixture signal 202 and the second mixture signal 204 to the noise suppression circuit 606, respectively.

Referring to FIG. 7, out of the speech from a speech source 310 that utters the desired speech, speech 311 toward the sound reflecting surface 751a that is a quadratic surface or a pseudo surface approximating a quadratic surface is reflected by the sound reflecting surface 751a and collected to the first microphone 301. Hence, the sound reflecting surface 751a functions as the first sound collector. Noise 322 from a noise source 320 that generates noise also gets around, and a first mixture sound including the noise 322 and the collected speech 311 is input to the first microphone 301. On the other hand, out of the noise from the noise source 320, noise 321 toward the sound reflecting surface 752a that is a quadratic surface or a pseudo surface approximating a quadratic surface is reflected by the sound reflecting surface 752a and collected to the second microphone 303. Hence, the sound reflecting surface 752a functions as the second sound collector. Speech 312 from the speech source 310 also gets around, and a second mixture sound including the speech 312 and the collected noise 321 is input to the second microphone 303.

Note that although not illustrated, rotation of the sound reflecting surface 752a serving as the second sound collector about the axis 753 is performed by a stepping motor or the like based on the control signal 641 from the sound collection controller 640. However, the present invention is not limited to this. In addition, although FIG. 7 illustrates one-dimensional rotation about the axis 753, two-dimensional or three-dimensional rotation is also possible. The first and second microphone support members 751 and 752 are preferably sound insulators that shield sound transmission and are disposed at positions where the first sound collector and the second sound collector are sandwiched between the microphone support members 751 and 752 and the first microphone and the second microphone, respectively.

(Example of Microphone Set Including Moving Sound Collector)

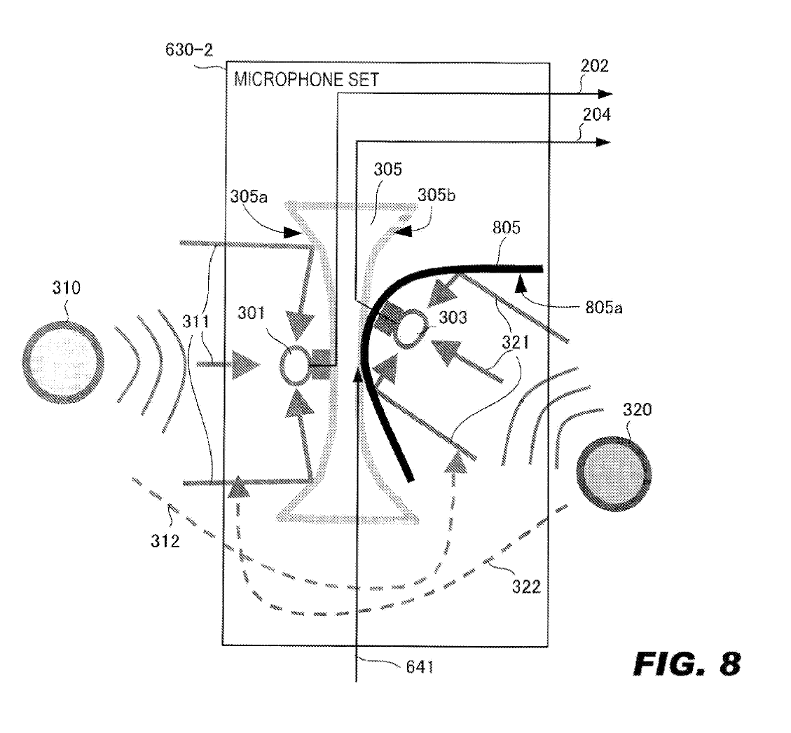

FIG. 8 is a view showing another example 630-2 of the microphone set 630 including a sound collector 805 serving as the moving second sound collector according to this embodiment. Note that the moving unit that moves the second sound collector is not illustrated. For example, a stepping motor or the like is disposed to automatically adjust the direction of the second sound collector.

The microphone set 630-2 includes the first microphone 301, the second microphone 303, a microphone support member 305 including a sound reflecting surface 305a serving as a first sound collector on which the first microphone 301 is disposed, and the sound collector 805 serving as a second sound collector movable to collect noise to the second microphone 303. In the microphone support member 305, a sound reflecting surface 305a on which the first microphone 301 is disposed is a concave surface formed from a quadratic surface or a pseudo surface approximating a quadratic surface. The first microphone 301 is disposed at the focus position of the quadratic surface or the pseudo surface approximating a quadratic surface. On the other hand, the sound collector 805 serving as the second sound collector is in rotatable contact with a curved surface 305b of the microphone support member 305 together with the second microphone 303. Such rotatable contact can be achieved by, for example, a magnet. However, the present invention is not limited to this. A sound reflecting surface 805a of the sound collector 805 serving as the second sound collector forms a quadratic surface or a pseudo surface approximating a quadratic surface. The second microphone 303 is disposed at the focus position of the quadratic surface or the pseudo surface approximating a quadratic surface. The first microphone 301 and the second microphone 303 output the first mixture signal 202 and the second mixture signal 204 to the noise suppression circuit 606, respectively.

Referring to FIG. 8, out of the speech from the speech source 310 that utters the desired speech, the speech 311 toward the sound reflecting surface 305a that is a quadratic surface or a pseudo surface approximating a quadratic surface is reflected by the sound reflecting surface 305a and collected to the first microphone 301. Hence, the sound reflecting surface 305a functions as the first sound collector. The noise 322 from the noise source 320 that generates noise also gets around, and a first mixture sound including the noise 322 and the collected speech 311 is input to the first microphone 301. On the other hand, out of the noise from the noise source 320, the noise 321 toward the sound reflecting surface 805a that is a quadratic surface or a pseudo surface approximating a quadratic surface is reflected by the sound reflecting surface 805a and collected to the second microphone 303. Hence, the sound reflecting surface 805a functions as the second sound collector. The speech 312 from the speech source 310 also gets around, and a second mixture sound including the speech 312 and the collected noise 321 is input to the second microphone 303.

Note that although not illustrated, rotation of the sound reflecting surface 805a serving as the second sound collector is performed based on the control signal 641 from the sound collection controller 640. In addition, although FIG. 8 illustrates one-dimensional rotation, two-dimensional or three-dimensional rotation is also possible. The microphone support member 305 is preferably a sound insulator that shields sound transmission.

<Hardware Arrangement of Speech Processing Apparatus According to this Embodiment>

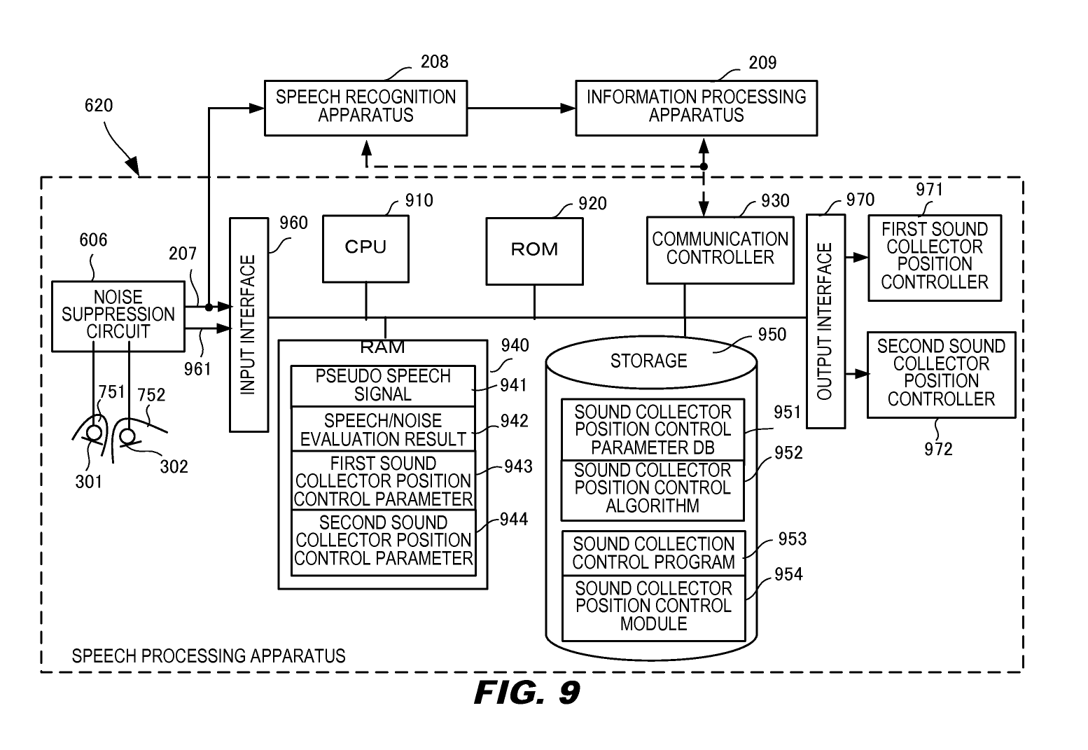

FIG. 9 is a block diagram showing the hardware arrangement of the speech processing apparatus according to this embodiment. Note that FIG. 9 also illustrates data used in the next fourth embodiment. FIG. 9 illustrates the speech recognition apparatus 208 and the information processing apparatus 209 connected to the speech processing apparatus 620.

Referring to FIG. 9, a CPU 910 is a processor for arithmetic control and implements the controller of the speech processing apparatus 620 by executing a program. A ROM 920 stores initial data, permanent data of programs and the like, and the programs. A communication controller 930 exchanges information between the speech processing apparatus 620, the speech recognition apparatus 208, and the information processing apparatus 209. The communication can be either wired or wireless. Note that FIG. 9 illustrates the noise suppression circuit 606 as a unique functional component. However, processing of the noise suppression circuit 606 may be implemented partially or wholly by processing of the CPU 910.

A RAM 940 is a random access memory used by the CPU 910 as a work area for temporary storage. Areas to store data necessary for implementing the embodiment are allocated in the RAM 940. The areas store digital data 941 of the pseudo speech signal 207 output from the noise suppression circuit 206 and an evaluation result 942 obtained by evaluating the speech input to the microphone based on the strength of the speech signal, the ratio of the speech and noise, and the like. The RAM 940 also stores a first sound collector position control parameter 943 determined from the evaluation result 942, and a second sound collector position control parameter 944 determined from the evaluation result 942.

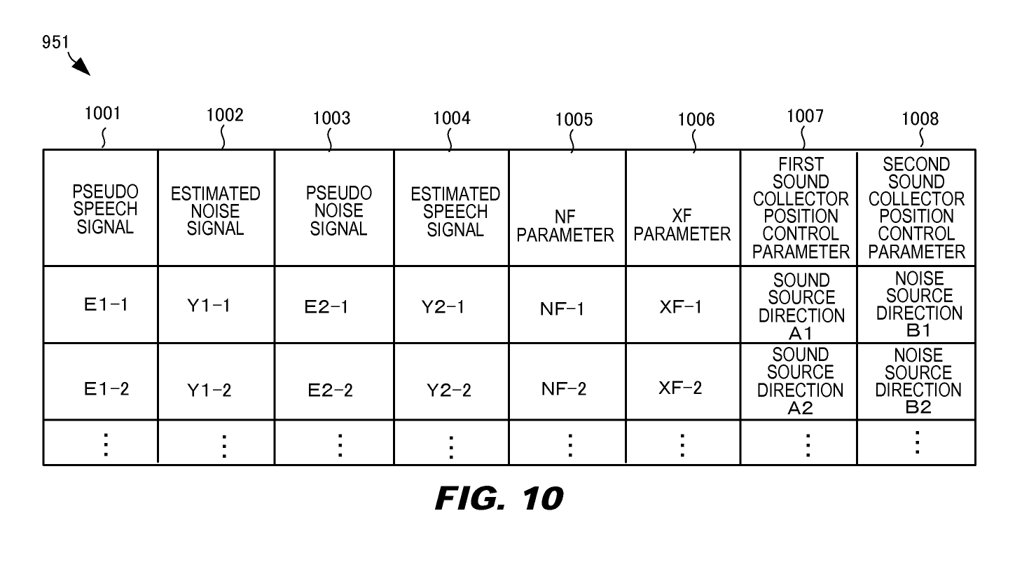

A storage 950 is a mass storage device that nonvolatilely stores databases, various kinds of parameters, and programs to be executed by the CPU 910. The storage 950 stores the following data and programs necessary for implementing the embodiment. As a data storage, the storage 950 stores a sound collector position control parameter DB 951 used to determine the first sound collector position control parameter 943 or the second sound collector position control parameter 944 from the evaluation result 942 (see FIG. 10). The storage 950 also stores a sound collector position control algorithm 952 such as an arithmetic expression used to determine the first sound collector position control parameter 943 or the second sound collector position control parameter 944 from the evaluation result 942 as needed without using the sound collector position control parameter DB 951. In this embodiment, the storage 950 stores, as a program, a sound collection control program 953 used to control sound collection. The storage 950 also stores a sound collector position control module 954 that controls the sound collector position.

An input interface 960 inputs control signals and data necessary for control by the CPU 910. In this embodiment, the input interface 960 inputs the pseudo speech signal 207 output from the noise suppression circuit 206 and a parameter of an adaptive filter NF 502 or an adaptive filter XF 504 or a parameter 961 of an estimated noise signal Y1 or the like. The parameter 961 is used to control the position of the sound collector. An output interface 970 outputs control signals and data to a device under the control of the CPU 910. In this embodiment, the output interface 970 outputs the first sound collector position control parameter 943 to a first sound collector position controller 971 or outputs the second sound collector position control parameter 944 to a second sound collector position controller 972. If the first sound collector position controller 971 or the second sound collector position controller 972 includes a motor, the first sound collector position control parameter 943 or the second sound collector position control parameter 944 includes a rotation direction and a rotation angle.

Note that FIG. 9 illustrates only the data and programs indispensable in this embodiment but not general-purpose data and programs such as the OS. The CPU 910 in FIG. 9 may also control the speech recognition apparatus 208 or the information processing apparatus 209.

(Arrangement of Sound Collector Position Control Parameter DB)

FIG. 10 is a view showing the arrangement of the sound collector position control parameter DB 951 according to this embodiment.

The sound collector position control parameter DB 951 includes, as a condition, at least one of a pseudo speech signal 1001, an estimated noise signal 1002, a pseudo noise signal 1003, an estimated speech signal 1004, a parameter 1005 of the adaptive filter NF, and a parameter 1006 of the adaptive filter XF acquired from the noise suppression circuit 206. A first sound collector position control parameter 1007 and a second sound collector position control parameter 1008 are stored in association with the condition. Note that each of the first sound collector position control parameter 1007 and the second sound collector position control parameter 1008 stores a change angle in one direction for one-dimensional movement, change angles in two directions for two-dimensional movement, or change angles in three directions for three-dimensional movement.

<Operation Procedure of Speech Processing Apparatus According to this Embodiment>

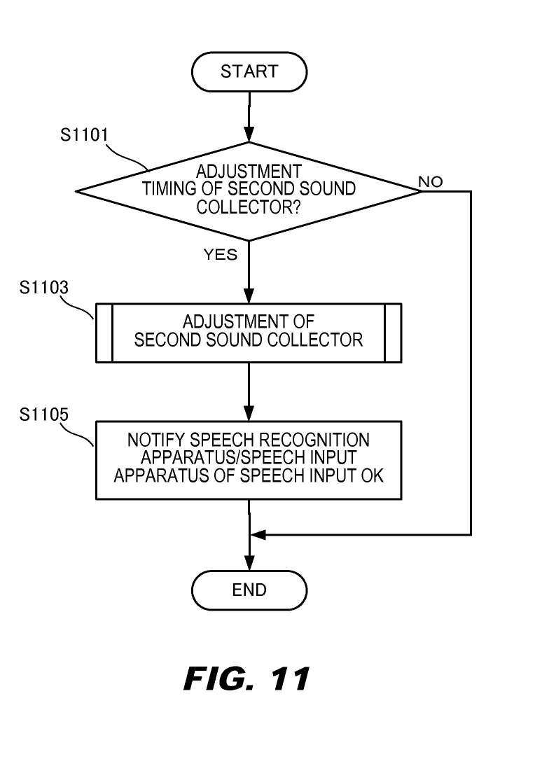

FIG. 11 is a flowchart showing a speech processing procedure according to this embodiment. The CPU 910 shown in FIG. 9 executes the flowchart of FIG. 11 using the RAM 940, thereby implementing the sound collection controller 640 shown in FIG. 6.

In step S1101, it is judged whether the timing of adjusting the second sound collector has come. If the timing of adjusting the second sound collector has not come, the processing ends. Note that the timing of adjusting the second sound collector is, for example, the time of initialization, the time at which the speech recognition of the speech recognition apparatus has failed, or the time at which the noise input has been judged to be small based on a pseudo noise signal E2 in the noise suppression circuit or the parameter of the adaptive filter NF.

If the timing of adjusting the second sound collector has come, position adjustment of the second sound collector is performed in step S1103. When the position adjustment of the second sound collector has ended, the speech recognition apparatus 208 and/or the information processing apparatus 209 is notified of the preparation completion or start of speech input through the communication controller 930 in step S1105.

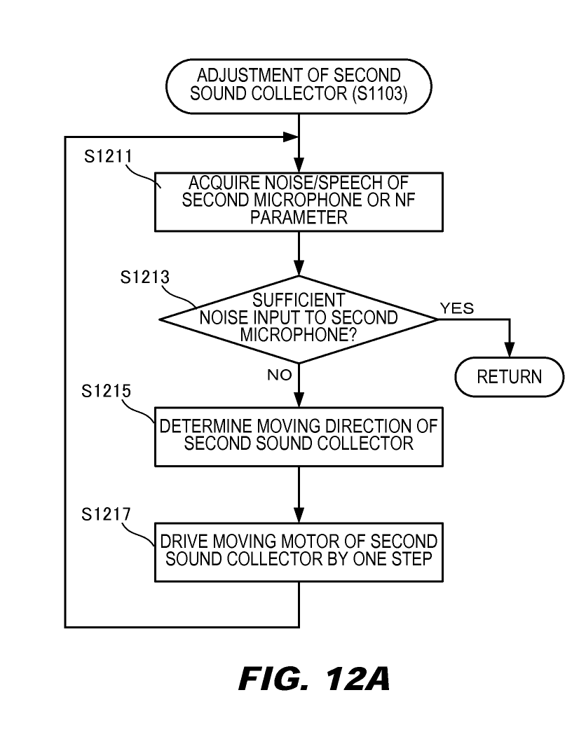

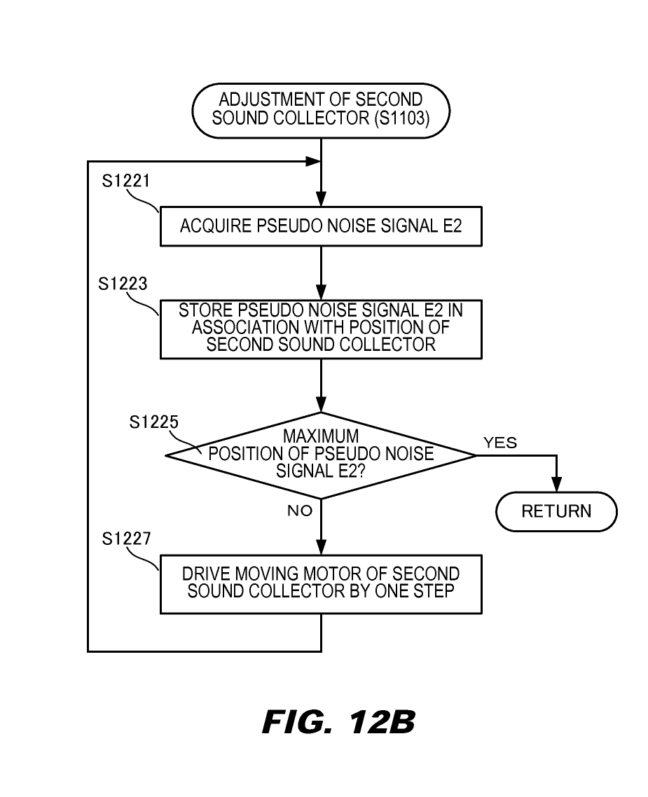

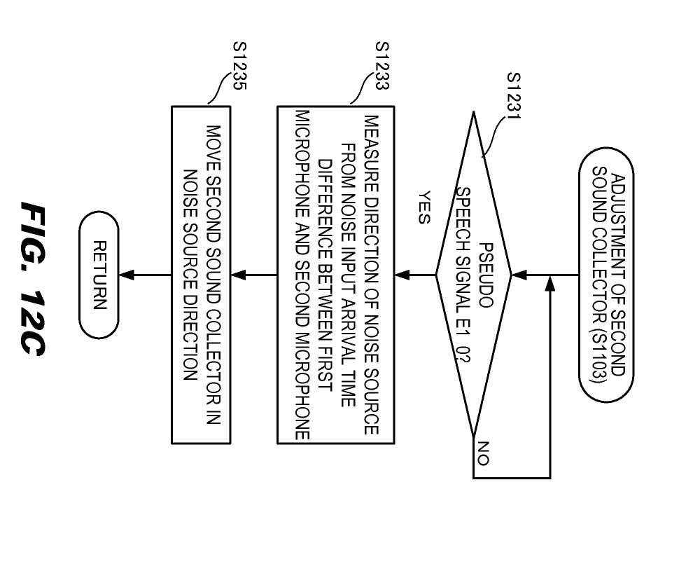

Various methods are usable for the position adjustment of the second sound collector in step S1103. FIGS. 12A to 12C show three examples.

(First Example of Second Sound Collector Adjustment Procedure)

FIG. 12A is a flowchart showing the first example of the second sound collector adjustment procedure according to this embodiment. In the example of FIG. 12A, the second sound collector is adjusted based on the output signal or a parameter from the noise suppression circuit so as to increase the noise input to the second microphone.

In step S1211, the ratio of noise and speech in the second microphone, the parameter of the adaptive filter NF, and the like are acquired from the noise suppression circuit. In step S1213, it is judged based on the data acquired in step S1211 whether the noise input to the second microphone is sufficient. If the noise input to the second microphone is sufficient, the processing ends and returns.

If the noise input to the second microphone is not sufficient, the moving direction of the second sound collector is determined based on the acquired data in step S1215. In step S1217, the moving motor of the second sound collector is driven by one step. Then, the process returns to step S1211 to repeat the processing until the noise is sufficiently input to the second microphone.

(Second Example of Second Sound Collector Adjustment Procedure)

FIG. 12B is a flowchart showing the second example of the second sound collector adjustment procedure according to this embodiment. In the example of FIG. 12B, the second sound collector is gradually moved in the vertical and horizontal directions so as to face a direction in which the noise volume increases, thereby adjusting the second sound collector to increase the noise input to the second microphone.

In step S1221, a pseudo noise signal E2 is acquired from the noise suppression circuit. In step S1223, the acquired pseudo noise signal E2 is stored in association with the position (angle) of the second sound collector. In step S1225, it is judged whether the pseudo noise signal E2 at that position has the maximum value larger than the values at adjacent positions in the vertical and horizontal directions. If the pseudo noise signal E2 has the maximum value at that position, the processing ends and returns. If the pseudo noise signal E2 does not have the maximum value at that position, the moving motor of the second sound collector is driven by one step in step S1227. Then, the process returns to step S1221 to repeat the processing until the second sound collector is located at the position (in the direction) where the pseudo noise signal E2 has the maximum value.

(Third Example of Second Sound Collector Adjustment Procedure)

FIG. 12C is a flowchart showing the third example of the second sound collector adjustment procedure according to this embodiment. In the example of FIG. 12C, the direction of the noise source is determined using two microphones without speech utterance, thereby adjusting the second sound collector to increase the noise input to the second microphone.

In step S1231, it is judged whether a pseudo speech signal E1 is almost zero. When the pseudo speech signal E1 is almost zero, it is estimated that there is almost no speech, and only noise is input, and the process advances to step S1333. In step S1333, the direction of the noise source is estimated from the time delay that is the difference in noise arrival time between the first microphone and the second microphone. In step S1335, the second sound collector is returned to the estimated noise source direction.

### Fourth Embodiment

In the third embodiment, the position of the second sound collector is made adjustable to increase input of noise to the second microphone in correspondence with the changing noise source. In the fourth embodiment, the position of the first sound collector is also made adjustable, and adjustment is performed to increase input of desired speech. According to this embodiment, the input of the desired speech is increased in correspondence with the change in the position of the speech source that utters the desired speech as well, and more correct pseudo speech is reconstructed. Note that a description of an arrangement and processing common to the second and third embodiments will be omitted.

<Arrangement of Information Processing System Including Speech Processing Apparatus According to this Embodiment>

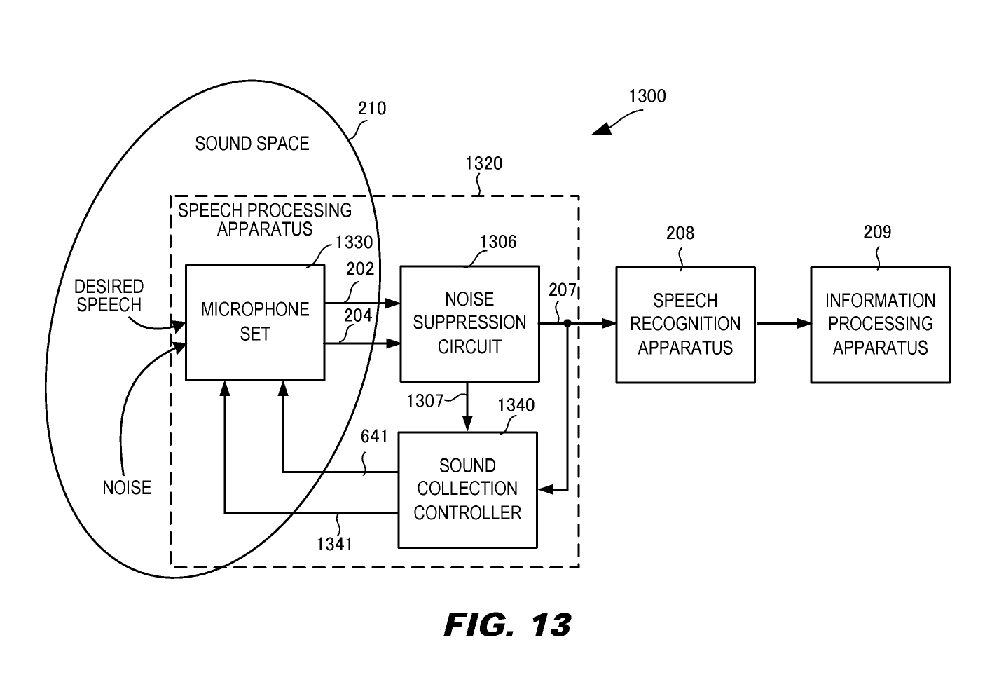

FIG. 13 is a block diagram showing the arrangement of an information processing system 1300 including a speech processing apparatus 1320 according to this embodiment.

Note that referring to FIG. 13, the speech processing apparatus 1320 includes a microphone set 1330 in which a first microphone, a second microphone, a first sound collector, and a second sound collector are integrally fixed, a noise suppression circuit 1306, and a sound collection controller 1340. The information processing system 1300 includes the speech processing apparatus 1320, and additionally, a speech recognition apparatus 208 and an information processing apparatus 209. Note that the fourth embodiment is different from the third embodiment in that the direction of the first sound collector of the microphone set 1330 can be changed toward the speech source. This different point will be described below. The arrangement and operation are similar to those of the second sound collector according to the third embodiment, and a detailed description thereof will be omitted.

In this embodiment, the second sound collector of the microphone set 1330 moves to increase noise input based on a control signal 641 from the sound collection controller 1340. In addition, the first sound collector of the microphone set 1330 moves to increase desired speech input based on a control signal 1341 from the sound collection controller 1340.

The sound collection controller 1340 outputs the control signal 1341 that changes the speech collection direction of the first sound collector in the microphone set 1330 and the control signal 641 that changes the noise collection direction of the second sound collector based on a pseudo speech signal 207 or a parameter 1307 of the noise suppression circuit 1306.

In the above-described way, the mixture sound including the desired speech and noise generated in the same sound space is input, at different mixture ratios, to the first microphone to which the desired speech is collected by the first sound collector and the second microphone to which the noise is collected by the second sound collector. The noise suppression circuit 1306 reconstructs the pseudo speech signal based on the first mixture signal from the first microphone and the second mixture signal from the second microphone. The speech recognition apparatus 208 recognizes the reconstructed pseudo speech signal. The information processing apparatus 209 processes information based on the recognized speech.

Note that the signal lines that transmit a first mixture signal 202 and a second mixture signal 204 may transmit the return signal of a ground power supply or the like or a power supply for operating the microphone. The noise suppression circuit 1306 or the sound collection controller 1340 may be attached to the microphone set 1330. In this case, the pseudo speech signal is output from the microphone set. In this embodiment, speech recognition will be explained. However, the present invention is not limited to this, and correct reconstruction of the uttered speech is useful in another processing as well. For example, application to a telephone or application to a manipulation of a vehicle or a device is also possible.

<Operation Procedure of Speech Processing Apparatus According to this Embodiment>

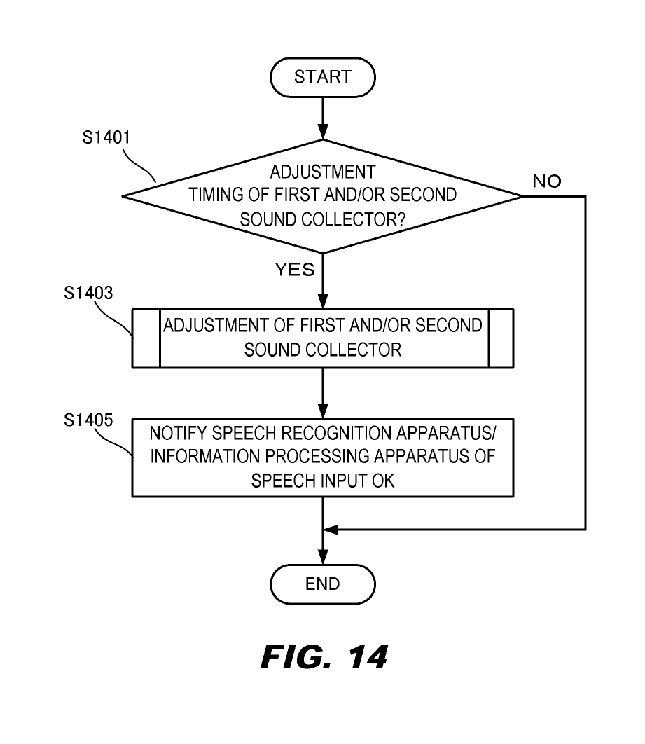

FIG. 14 is a flowchart showing a speech processing procedure according to this embodiment. A CPU 910 shown in FIG. 9 executes the flowchart of FIG. 14 using a RAM 940, thereby implementing the sound collection controller 1340 shown in FIG. 13.

In step S1401, it is judged whether the timing of adjusting the first sound collector and/or the second sound collector has come. If the adjustment timing has not come, the processing ends. Note that the timing of adjusting the first sound collector and/or the second sound collector is, for example, the time of initialization or the time at which the speech recognition of the speech recognition apparatus has failed. Alternatively, the timing is, for example, the time at which the noise input has been judged to be small based on a pseudo noise signal E2 in the noise suppression circuit or the parameter of the adaptive filter NF or the time at which the speech input has been judged to be small based on a pseudo speech signal E1 or the parameter of the adaptive filter XF.

If the timing of adjusting the first sound collector and/or the second sound collector has come, position adjustment of the first sound collector and/or the second sound collector is performed in step S1403. Various methods are usable for the position adjustment of the first sound collector and/or the second sound collector. Several examples have been explained above in accordance with FIGS. 12A to 12C, and a description thereof will be omitted here.

When the position adjustment of the first sound collector and/or the second sound collector has ended, the speech recognition apparatus 208 and/or the information processing apparatus 209 is notified of the preparation completion or start of speech input via a communication controller 930 in step S1405.

### Fifth Embodiment

In the second and fourth embodiments, the general-purpose arrangement and operation of the information processing system including the speech processing apparatus have been described. In the fifth to eighth embodiments, several examples will be explained in which the information processing system including the speech processing apparatus is applied to a detailed information processing system.

In the fifth embodiment, the information processing system including the speech processing apparatus is assumed to be a vehicle system, which uses a microphone set 230-2 shown in FIG. 3B in which the directions of the first microphone and the second microphone are set at different angles. According to this embodiment, it is possible to correctly transmit an occupant's speech instruction to a car navigation apparatus during driving of a vehicle by suppressing noise in the vehicle, for example, noise generated by an air conditioner.

<Arrangement of Information Processing System Including Speech Processing Apparatus According to this Embodiment>

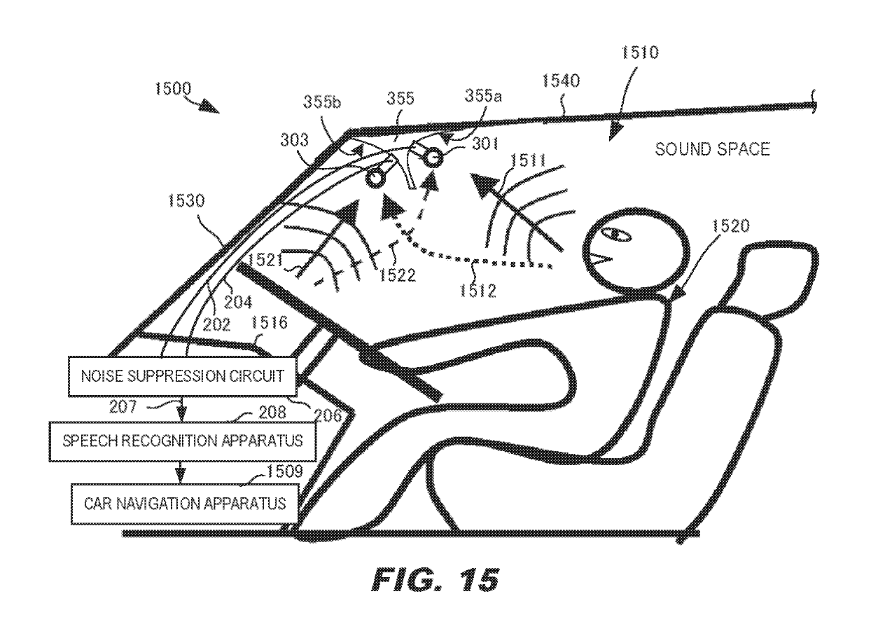

FIG. 15 is a block diagram showing the arrangement of a vehicle system 1500 that is an information processing system including a speech processing apparatus according to this embodiment. Note that referring to FIG. 15, the speech processing apparatus includes a first microphone 301, a second microphone 303, a microphone support member 355 including, on both sides, a sound reflecting surface 355a serving as a first sound collector that collects speech to the first microphone 301 and a sound reflecting surface 355b serving as a second sound collector that collects noise to the second microphone 303, and a noise suppression circuit 206. Note that the microphone support member 355 is preferably a sound insulator. The vehicle system 1500 includes the speech processing apparatus, and additionally, a speech recognition apparatus 208 and a car navigation apparatus 1509 that is an information processing apparatus. Note that the first microphone 301, the second microphone 303, and the microphone support member 355 serving as a sound insulator may be provided as a microphone set that is an integral speech input unit.

Referring to FIG. 15, a sound space 1510 is the space in a vehicle. The sound space 1510 shown in FIG. 15 is partially delimited by a windshield 1530 and a ceiling 1540. The arrangement and operation of this embodiment will be described below by exemplifying a case in which an occupant 1520 manipulates the car navigation apparatus 1509 by speech in the sound space 1510 where noise from an air conditioner or the like mixes. Note that the air conditioner is assumed to exist in a dashboard 1516. However, the noise source is not limited to the air conditioner and may be another device disposed at another position. The speech of the occupant 1520 need not always be used to manipulate the car navigation apparatus 1509.

In the speech processing apparatus according to this embodiment, the first microphone 301, the second microphone 303, and the microphone support member 355 serving as the sound insulator are disposed at the ceiling portion on the front side of the car. The microphone support member 355 has a portion projecting from the ceiling 1540 into the car, which crosses a line segment connecting the first microphone 301 and the noise source, thereby shielding airborne noise directly mixing from the noise source into the first microphone 301. The microphone support member 355 also shields solid borne noise transmitted from the noise source to the first microphone 301 through the windshield 1530 and the ceiling 1540. Note that the projecting portion of the microphone support member 355 may also serve as a sun visor. In this case, it is particularly preferable to make the sun visor using a material that is transparent without direct sunlight, but upon receiving direct sunlight, becomes opaque and thus shields the sunlight.

The first microphone 301 receives a first mixture sound including airborne speech 1511 uttered by the occupant 1520 and collected by the sound reflecting surface 355a serving as the first sound collector and airborne noise 1522 that has got around. The first microphone 301 converts the first mixture sound into a first mixture signal 202 including a speech signal and a noise signal and transmits it to the noise suppression circuit 206. On the other hand, the second microphone 303 receives a second mixture sound including airborne noise 1521 collected by the sound reflecting surface 355b serving as the second sound collector and airborne speech 1512 that has got around at a ratio different from the first mixture sound. The second microphone 303 converts the second mixture sound into a second mixture signal 204 including a speech signal and a noise signal at a ratio different from the first mixture signal and transmits it to the noise suppression circuit 206.

The noise suppression circuit 206 outputs a pseudo speech signal 207 based on the transmitted first mixture signal 202 and second mixture signal 204. The pseudo speech signal 207 is recognized by the speech recognition apparatus 208 and processed by the car navigation apparatus 1509 as a manipulation by the speech of the occupant 1520.

In the above-described way, in the sound space 1510 of the vehicle where the desired speech and the in-car noise mix, speech uttered by the occupant 1520 and indicating a manipulation of the car navigation apparatus 1509 is input to the sound reflecting surface 355a serving as the first sound collector and the first microphone 301 and the sound reflecting surface 355b serving as the second sound collector and the second microphone 303 as mixture sounds of different mixture ratios. The noise suppression circuit 206 reconstructs the pseudo speech signal based on the first mixture signal from the first microphone 301 and the second mixture signal from the second microphone 303. The speech recognition apparatus 208 recognizes the reconstructed pseudo speech signal. The car navigation apparatus 1509 is manipulated by the recognized speech.

Note that the signal lines that transmit the first mixture signal 202 and the second mixture signal 204 may transmit the return signal of a ground power supply or the like or a power supply for operating the microphone. The noise suppression circuit 206 may be attached to the microphone support member 355. In this case, the pseudo speech signal is transmitted from the noise suppression circuit 206 to the speech recognition apparatus 208 through a signal line. In this embodiment, speech recognition and car navigation will be explained. However, the present invention is not limited to this, and correct reconstruction of the speech uttered by the occupant 1520 is useful in another processing as well. For example, application to an automobile telephone or application to a vehicle manipulation that is not directly associated with driving is also possible.

### Sixth Embodiment

In the sixth embodiment, the information processing system including the speech processing apparatus is assumed to be a vehicle system, which uses a microphone set with a microphone support member separated in FIG. 8 in which the direction of the second sound collector that collects noise is adjustable. According to this embodiment, it is possible to correctly transmit an occupant's speech instruction to a car navigation apparatus during driving of a vehicle by suppressing noise uttered by a number of noise sources in the vehicle.

<Arrangement of Information Processing System Including Speech Processing Apparatus According to this Embodiment>

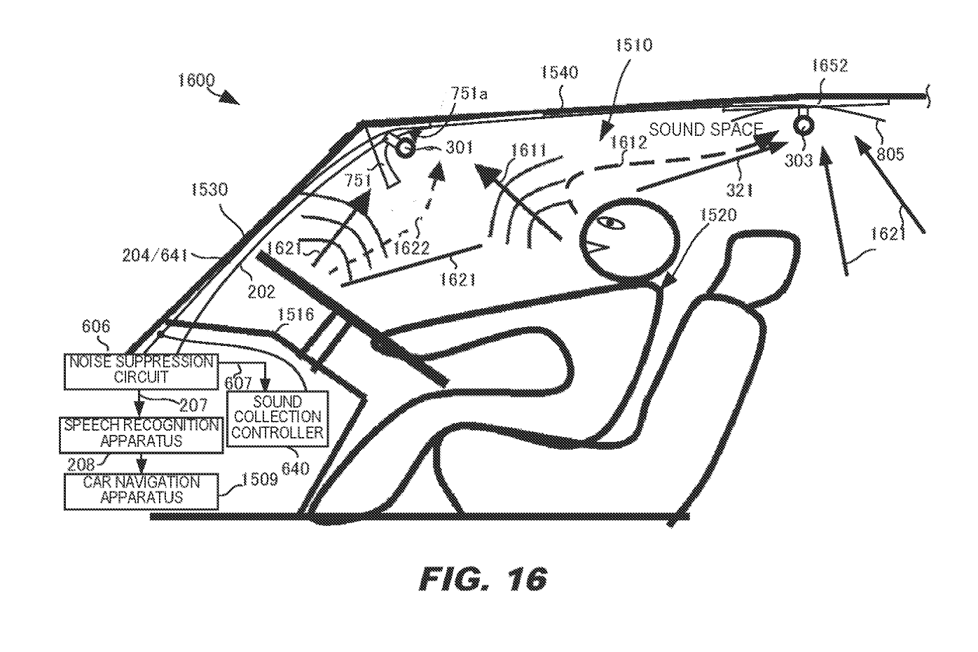

FIG. 16 is a block diagram showing the arrangement of a vehicle system 1600 that is an information processing system including a speech processing apparatus according to this embodiment. Note that referring to FIG. 16, the speech processing apparatus includes a first microphone 301, a second microphone 303, a first microphone support member 751 including a sound reflecting surface 751a serving as a first sound collector that collects speech to the first microphone 301, a second microphone support member 1652 including a sound collector 805 serving as a movable second sound collector that collects speech to the second microphone 303, a noise suppression circuit 606, and a sound collection controller 640. The first microphone support member 751 is preferably a sound insulator. The vehicle system 1600 includes the speech processing apparatus, and additionally, a speech recognition apparatus 208 and a car navigation apparatus 1509 that is an information processing apparatus. Note that the first microphone 301, the second microphone 303, the first microphone support member 751, the second microphone support member 1652, and the sound collector 805 serving as the second sound collector may be provided as a microphone set that is a speech input unit.

The points of difference between the fifth embodiment and this embodiment shown in FIG. 16, that is, the layout position of the second microphone 303 and control of the direction of the sound collector 805 serving as the second sound collector will be described below, and a description of the rest will be omitted.

In the speech processing apparatus according to this embodiment, the first microphone 301 and the first microphone support member 751 serving as the sound insulator are disposed at the ceiling portion on the front side of the car. The sound reflecting surface 751a serving as the first sound collector of the first microphone support member 751 collects speech uttered by an occupant 1520 and inputs it to the first microphone 301. The first microphone support member 751 has a portion projecting from a ceiling 1540 into the car, which crosses a line segment connecting the first microphone 301 and the noise source (particularly, for example, an air conditioner in a dashboard), thereby shielding airborne noise directly mixing from the noise source to the first microphone 301. The first microphone support member 751 also shields solid borne noise transmitted from the noise source to the first microphone 301 through a windshield 1530 and the ceiling 1540. Note that the projecting portion of the first microphone support member 751 may also serve as a sun visor. In this case, it is particularly preferable to make the sun visor using a material that is transparent without direct sunlight, but upon receiving direct sunlight, becomes opaque and thus shields the sunlight.

The second microphone and the sound collector 805 serving as the second sound collector are installed so as to be able to change their directions on the second microphone support member 1652 at the center of the ceiling where more noise can be collected from a plurality of noise sources in the car. The directions of the second microphone and the sound collector 805 serving as the second sound collector are controlled by a moving controller (for example, motor) (not shown) based on a control signal 641 from the sound collection controller 640 to collect more noise from the plurality of noise sources in the car.

The first microphone 301 receives a first mixture sound including airborne speech 1611 uttered by the occupant 1520 and collected by the sound reflecting surface 751a serving as the first sound collector and airborne noise 1622 that has got around. The first microphone 301 converts the first mixture sound into a first mixture signal 202 including a speech signal and a noise signal and transmits it to the noise suppression circuit 606. On the other hand, the second microphone 303 receives a second mixture sound including airborne noise 1621 generated from a plurality of noise sources and collected by the sound collector 805 serving as the second sound collector and airborne speech 1612 that has got around at a ratio different from the first mixture sound. The second microphone 303 converts the second mixture sound into a second mixture signal 204 including a speech signal and a noise signal at a ratio different from the first mixture signal and transmits it to the noise suppression circuit 606.

The noise suppression circuit 606 outputs a pseudo speech signal 207 and a parameter 607 to be used by the sound collection controller 640 based on the transmitted first mixture signal 202 and second mixture signal 204. The pseudo speech signal 207 is recognized by the speech recognition apparatus 208 and processed by the car navigation apparatus 1509 as a manipulation by the speech of the occupant 1520.

The sound collection controller 640 outputs the control signal 641 to control the directions of the second microphone 303 and the sound collector 805 serving as the second sound collector based on the pseudo speech signal 207 and the parameter 607 from the noise suppression circuit 606.

In the above-described way, in a sound space 1510 of the vehicle where the desired speech and the in-car noise mix, speech uttered by the occupant 1520 and indicating a manipulation of the car navigation apparatus 1509 is input to the sound reflecting surface 751a serving as the first sound collector and the first microphone 301 and the sound collector 805 serving as the second sound collector and the second microphone 303 whose directions are adjusted to collect more in-car noise as mixture sounds of different mixture ratios. The noise suppression circuit 606 reconstructs the pseudo speech signal based on the first mixture signal from the first microphone 301 and the second mixture signal from the second microphone 303. The speech recognition apparatus 208 recognizes the reconstructed pseudo speech signal. The car navigation apparatus 1509 is manipulated by the recognized speech.

Note that the noise suppression circuit 606 or the sound collection controller 640 may be attached to the first microphone support member 751 or the second microphone support member 1652. In this case, the pseudo speech signal is transmitted from the noise suppression circuit 606 to the speech recognition apparatus 208 through a signal line. In this embodiment, speech recognition and car navigation will be explained. However, the present invention is not limited to this, and correct reconstruction of the speech uttered by the occupant 1520 is useful in another processing as well. For example, application to an automobile telephone or application to a vehicle manipulation that is not directly associated with driving is also possible.

### Seventh Embodiment

In the seventh embodiment, the information processing system including the speech processing apparatus is assumed to be a personal computer (to be abbreviated as a PC hereinafter) and, more particularly, a notebook PC, which uses a microphone set 230-1 shown in FIG. 3B in which a first microphone and a second microphone are installed on both sides of a microphone support member. According to this embodiment, it is possible to correctly transmit an operator's speech instruction to the notebook PC by suppressing noise in the room, for example, noise generated by a device such as an air conditioner or speech uttered by another person.

<Arrangement of Information Processing System Including Speech Processing Apparatus According to this Embodiment>

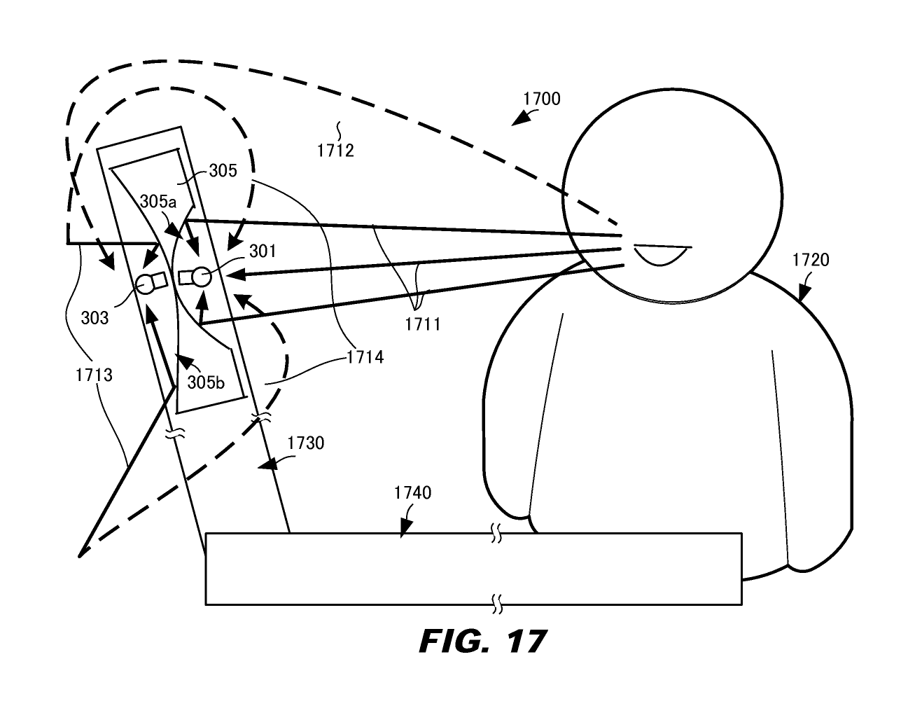

FIG. 17 is a block diagram showing the arrangement of a notebook personal computer (to be referred to as a notebook PC 1700 hereinafter) that is an information processing system including a speech processing apparatus according to this embodiment. Note that referring to FIG. 17, a description of the primary functions of the notebook PC will be omitted, and an arrangement concerning sound collection to a first microphone 301 and a second microphone 303 will be explained as the feature of this embodiment.

Referring to FIG. 17, the notebook PC 1700 includes a display portion 1730 including a display screen and a keyboard portion 1740 including a keyboard. In this embodiment, the first microphone 301, the second microphone 303, and a microphone support member 305 having a sound reflecting surface 305a serving as a first sound collector and a sound reflecting surface 305b serving as a second sound collector on both sides, which construct the microphone set 230-1, are disposed in the display portion 1730. That is, the first microphone 301 and the sound reflecting surface serving as the first sound collector are disposed on the operator side of the display portion 1730. The second microphone 303 and the sound reflecting surface 305b serving as the second sound collector are disposed on the side of the display portion 1730 opposite to the operator.

The first microphone 301 receives a first mixture sound including speech 1711 uttered by an operator 1720 and collected by the sound reflecting surface 305a serving as the first sound collector and airborne noise 1714 that has got around. The first microphone 301 converts the first mixture sound into a first mixture signal including a speech signal and a noise signal and transmits it to a noise suppression circuit 206 (not shown). On the other hand, the second microphone 303 receives a second mixture sound including airborne noise 1713 collected by the sound reflecting surface 305b serving as the second sound collector and speech 1712 that has got around at a ratio different from the first mixture sound. The second microphone 303 converts the second mixture sound into a second mixture signal including a speech signal and a noise signal at a ratio different from the first mixture signal and transmits it to the noise suppression circuit 206 (not shown).

The noise suppression circuit 206 outputs a pseudo speech signal 207 based on the first mixture signal and the second mixture signal transmitted from the first microphone 301 and the second microphone 303, respectively. The pseudo speech signal 207 is recognized by a speech recognition apparatus 208 and processed by the notebook PC 1700 as a manipulation by speech or speech input of data by the operator 1720.

In the above-described way, in the sound space where the desired speech and indoor noise mix, speech uttered by the operator 1720 to the notebook PC 1700 is input to the sound reflecting surface 305a serving as the first sound collector and the first microphone 301 and the sound reflecting surface 305b serving as the second sound collector and the second microphone 303 as mixture sounds of different mixture ratios. The noise suppression circuit 206 reconstructs the pseudo speech signal based on the first mixture signal from the first microphone 301 and the second mixture signal from the second microphone 303. The speech recognition apparatus 208 recognizes the reconstructed pseudo speech signal. The notebook PC 1700 processes the recognized speech.

### Eighth Embodiment

In the seventh embodiment, the first sound collector and the second sound collector are fixed to the microphone support member. In the eighth embodiment, the direction of the first sound collector that collects speech is made adjustable using an arrangement similar to that in FIG. 8 in which the direction of the second sound collector that collects noise is adjustable. In addition, a microphone set with a separated microphone support member is used. According to this embodiment, it is possible to correctly transmit an operator's speech instruction to a notebook PC by inputting collected loud speech and suppressing noise in the room, for example, noise generated by a device such as an air conditioner or speech uttered by another person.

<Arrangement of Information Processing System Including Speech Processing Apparatus According to this Embodiment>

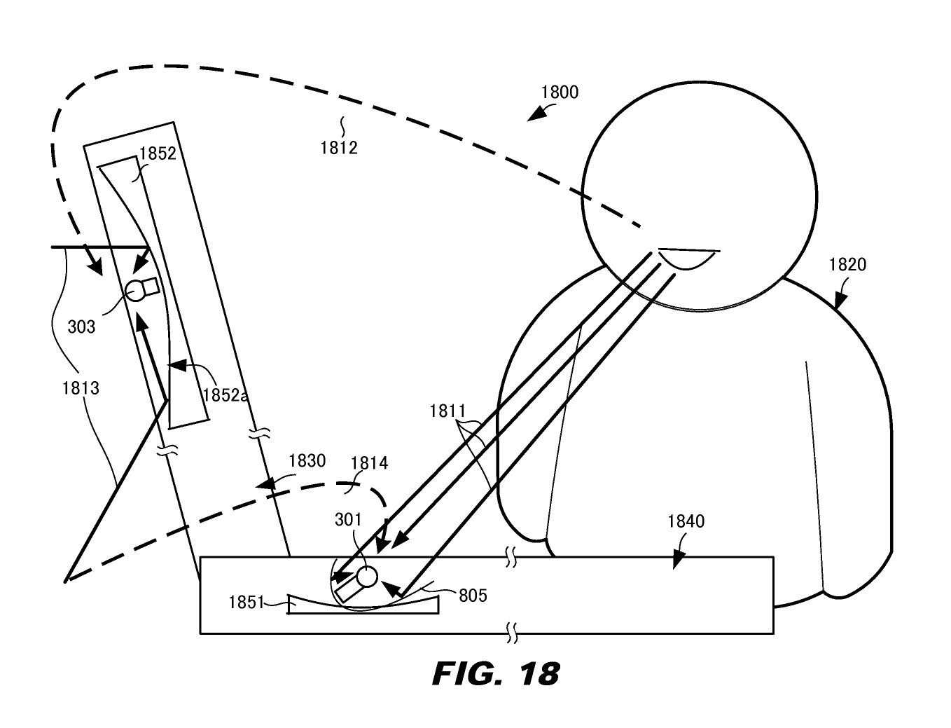

FIG. 18 is a block diagram showing the arrangement of a personal computer (notebook PC 1800) that is an information processing system including a speech processing apparatus according to this embodiment. Note that referring to FIG. 18, a description of the primary functions of the notebook PC will be omitted, and an arrangement concerning sound collection to a first microphone 301 and a second microphone 303 will be explained as the feature of this embodiment.

Referring to FIG. 18, the notebook PC 1800 includes a display portion 1830 including a display screen and a keyboard portion 1840 including a keyboard. In this embodiment, the first microphone 301, a sound collector 805 serving as a first sound collector, and a first microphone support member 1851, which construct a microphone set, are disposed in the display portion 1830. On the other hand, the second microphone 303 and a second microphone support member 1852 including a sound reflecting surface 1852a serving as a second sound collector are disposed in the keyboard portion 1840. That is, the first microphone 301 and the sound collector 805 serving as the first sound collector are disposed on the keyboard surface of the keyboard portion 1840. The second microphone 303 and the sound reflecting surface 1852a serving as the second sound collector are disposed on the side of the display portion 1830 opposite to the operator. The directions of the first microphone 301 and the sound collector 805 serving as the first sound collector are changed by, for example, judging the position of the operator from the angle made by the display portion 1830 and the keyboard portion 1840.

The first microphone 301 receives a first mixture sound including speech 1811 uttered by an operator 1820 and collected by the sound collector 805 serving as the first sound collector directed to the operator 1820 and airborne noise 1814 that has got around. The first microphone 301 converts the first mixture sound into a first mixture signal including a speech signal and a noise signal and transmits it to a noise suppression circuit 206 (not shown). On the other hand, the second microphone 303 receives a second mixture sound including airborne noise 1813 collected by the sound reflecting surface 1852a serving as the second sound collector and speech 1812 that has got around at a ratio different from the first mixture sound. The second microphone 303 converts the second mixture sound into a second mixture signal including a speech signal and a noise signal at a ratio different from the first mixture signal and transmits it to the noise suppression circuit 206 (not shown).

The noise suppression circuit 206 outputs a pseudo speech signal 207 based on the first mixture signal and the second mixture signal transmitted from the first microphone 301 and the second microphone 303, respectively. The pseudo speech signal 207 is recognized by a speech recognition apparatus 208 and processed by the notebook PC 1800 as a manipulation by speech or speech input of data by the operator 1820.

In the above-described way, in the sound space where the desired speech and indoor noise mix, speech uttered by the operator 1820 to the notebook PC 1800 is input to the sound collector 805 serving as the first sound collector and the first microphone 301 and the sound reflecting surface 1852a serving as the second sound collector and the second microphone 303 as mixture sounds of different mixture ratios. The noise suppression circuit 206 reconstructs the pseudo speech signal based on the first mixture signal from the first microphone 301 and the second mixture signal from the second microphone 303. The speech recognition apparatus 208 recognizes the reconstructed pseudo speech signal. The notebook PC 1800 processes the recognized speech.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention also incorporates a system or apparatus that somehow combines different features included in the respective embodiments.

The present invention is applicable to a system including a plurality of devices or a single apparatus. The present invention is also applicable even when a control program for implementing the functions of the embodiments is supplied to the system or apparatus directly or from a remote site. Hence, the present invention also incorporates the control program installed in a computer to implement the functions of the present invention on the computer, a medium storing the control program, and a WWW (World Wide Web) server that causes a user to download the control program.

This application claims the benefit of Japanese Patent Application No. 2011-005316 filed on Jan. 13, 2011, which is hereby incorporated by reference herein in its entirety.

1. A speech processing apparatus comprising:
a first microphone that inputs a first mixture sound including desired speech and noise and outputs a first mixture signal;
a second microphone that is opened to the same sound space as that of said first microphone, inputs a second mixture sound including the desired speech and the noise at a ratio different from the first mixture sound, and outputs a second mixture signal;
a first sound collector including a concave surface that collects the first mixture sound to said first microphone;
a second sound collector including a concave surface that collects the second mixture sound to said second microphone and disposed in a direction different from said first sound collector; and
a noise suppression circuit that suppresses an estimated noise signal based on the first mixture signal and the second mixture signal and outputs a pseudo speech signal.

2. The speech processing apparatus according to claim 1, wherein the concave surfaces of said first sound collector and said second sound collector are sound reflecting surfaces of quadratic surfaces whose focal points correspond to positions of said first microphone and said second microphone, respectively.

3. The speech processing apparatus according to claim 1, wherein the concave surfaces of said first sound collector and said second sound collector are sound reflecting surfaces of pseudo surfaces approximating quadratic surfaces whose focal points correspond to positions of said first microphone and said second microphone, respectively.

4. The speech processing apparatus according to claim 3, wherein the pseudo surface is an aggregate of planes extending in tangential directions of the quadratic surface.

5. The speech processing apparatus according to claim 1, wherein said first microphone is a microphone to which the desired speech is collected, and said second microphone is a microphone to which the noise is collected, and
a range perpendicular to an axis of a surface where the quadratic surface or the pseudo surface of said second sound collector performs sound collection is wider than a range perpendicular to the axis of the surface where the quadratic surface or the pseudo surface of said first sound collector performs sound collection.

6. The speech processing apparatus according to claim 1, further comprising a first moving unit that makes said first sound collector movable in a direction in which the desired speech is collected to said first microphone.

7. The speech processing apparatus according to claim 6, further comprising a first moving controller that controls movement of said first moving unit to increase the ratio of the desired speech in the first mixture sound input to said first microphone.

8. The speech processing apparatus according to claim 7, wherein said first moving controller changes a direction of said first sound collector.

9. The speech processing apparatus according to claim 7, wherein said first moving controller controls the movement of said first moving unit in accordance with a first parameter used by said noise suppression circuit.

10. The speech processing apparatus according to claim 1, further comprising a second moving unit that makes said second sound collector movable in a direction in which the noise is collected to said second microphone.

11. The speech processing apparatus according to claim 10, further comprising a second moving controller that controls movement of said second moving unit to increase the ratio of the noise in the second mixture sound input to said second microphone.

12. The speech processing apparatus according to claim 11, wherein said second moving controller changes a direction of said second sound collector.

13. The speech processing apparatus according to claim 11, wherein said second moving controller controls the movement of said second moving unit in accordance with a second parameter used by said noise suppression circuit.

14. The speech processing apparatus according to claim 11, wherein said second moving controller acquires information representing the noise included in the second mixture sound while changing the direction and controls movement of said second sound collector in a direction in which the noise is maximized

15. The speech processing apparatus according to claim 11, wherein said second moving controller estimates a position of a noise source based on a time delay between the noise in the first mixture sound input to said first microphone and the noise in the second mixture sound input to said second microphone under a condition without the desired speech, and controls movement of said second sound collector in a direction of the estimated noise source.

16. The speech processing apparatus according to claim 1, further comprising a sound insulator disposed between said first microphone and said second microphone.

17. The speech processing apparatus according to claim 16, wherein said first microphone and said first sound collector are attached to one surface of said sound insulator, said second microphone and said second sound collector are attached to other surface of said sound insulator, and said first microphone, said second microphone, said first sound collector, said second sound collector, and said sound insulator are provided as an integral speech input unit.

18. The speech processing apparatus according to claim 1, further comprising a first sound insulator attached to a position to sandwich said first sound collector with said first microphone and a second sound insulator attached to a position to sandwich said second sound collector with said second microphone.

19. The speech processing apparatus according to claim 1, wherein said noise suppression circuit comprises:
a first subtracter that subtracts the estimated noise signal estimated to be included in the first mixture signal from the first mixture signal;
a second subtracter that subtracts an estimated speech signal estimated to be included in the second mixture signal from the second mixture signal;
an estimated noise signal generator that generates the estimated noise signal from an output signal of said second subtracter; and
an estimated speech signal generator that generates the estimated speech signal from an output signal of said first subtracter, and
the pseudo speech signal is the output signal of said first subtracter.

20. A vehicle including a speech processing apparatus of claim 1,
wherein said first microphone and said first sound collector are disposed at a position where said first sound collector collects desired speech uttered by an occupant in a car to said first microphone, and
said second microphone and said second sound collector are disposed at a position where said second sound collector collects noise generated from a noise source in the car to said second microphone.

21. An information processing apparatus including a speech processing apparatus of claim 1,
wherein said first microphone and said first sound collector are disposed at a position where said second sound collector collects desired speech uttered by an operator of the information processing apparatus to said first microphone, and
said second microphone and said second sound collector are disposed at a position where said first sound collector collects noise generated from a noise source in the same sound space as the operator to said second microphone.

22. The information processing apparatus according to claim 21, wherein the information processing apparatus is a notebook personal computer, and
said first microphone and said first sound collector are disposed on one of a keyboard surface and a surface of a display on a side of the operator, and said second microphone and said second sound collector are disposed on a surface of the display opposite to the operator.

23. An information processing system including a speech processing apparatus of claim 1, comprising:
a speech recognition apparatus that recognizes desired speech from the pseudo speech signal output from the speech processing apparatus; and
an information processing apparatus that processes information in accordance with the desired speech recognized by said speech recognition apparatus.

24. A control method of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a first sound collector including a concave surface that collects the first mixture sound to the first microphone;
a second sound collector including a concave surface that collects the second mixture sound to the second microphone and disposed in a direction different from the first sound collector; and
a noise suppression circuit that suppresses an estimated noise signal based on the first mixture signal and the second mixture signal and outputs a pseudo speech signal, the method comprising:
acquiring a parameter of the noise suppression circuit;
determining, in accordance with the parameter of the noise suppression circuit, a direction of the second sound collector to increase the ratio of the noise in the second mixture sound input to the second microphone; and
controlling the direction of the second sound collector.

25. A non-transitory computer-readable storage medium storing a control program of a speech processing apparatus including:
a first microphone that inputs a first mixture sound including desired speech and noise and outputs a first mixture signal;
a second microphone that is opened to the same sound space as that of the first microphone, inputs a second mixture sound including the desired speech and the noise at a ratio different from the first mixture sound, and outputs a second mixture signal;
a first sound collector including a concave surface that collects the first mixture sound to the first microphone;
a second sound collector including a concave surface that collects the second mixture sound to the second microphone and disposed in a direction different from the first sound collector; and
a noise suppression circuit that suppresses an estimated noise signal based on the first mixture signal and the second mixture signal and outputs a pseudo speech signal, the control program causing a computer to execute:
acquiring a parameter of the noise suppression circuit;
determining, in accordance with the parameter of the noise suppression circuit, a direction of the second sound collector to increase the ratio of the noise in the second mixture sound input to the second microphone; and
controlling the direction of the second sound collector.

26. The speech processing apparatus according to claim 8, wherein said first moving controller controls the movement of said first moving unit in accordance with a first parameter used by said noise suppression circuit.

27. The speech processing apparatus according to claim 13, wherein said second moving controller controls the movement of said second moving unit in accordance with a second parameter used by said noise suppression circuit.

28. The speech processing apparatus according to claim 13, wherein said second moving controller acquires information representing the noise included in the second mixture sound while changing the direction and controls movement of said second sound collector in a direction in which the noise is maximized.

29. The speech processing apparatus according to claim 13, wherein said second moving controller estimates a position of a noise source based on a time delay between the noise in the first mixture sound input to said first microphone and the noise in the second mixture sound input to said second microphone under a condition without the desired speech, and controls movement of said second sound collector in a direction of the estimated noise source.
